(19) United States
(12) Patent Application Publication
(10) Pub. No.: US 2012/0202485 A1
(43) Pub. Date: Aug. 9, 2012

(54) SYSTEMS AND METHODS FOR AUDIO ROAMING FOR MOBILE DEVICES

(75) Inventors: Ramin Mirbaha, Dachau (DE); Vahid Mirbaha, Dachau (DE)

(73) Assignee: TakWak GmbH

(21) Appl. No.: 13/363,179

(22) Filed: Jan. 31, 2012

Related U.S. Application Data
(60) Provisional application No. 61/439,426, filed on Feb. 4, 2011.

(51) Int. Cl. H04W 4/08; H04W 12/02

(52) U.S. Cl. 455/426.1

(57) ABSTRACT

The present solution is directed to seamlessly communicating among mobile devices comprising a private mobile radio module. Multiple mobile devices establish a group. Each mobile device comprises a cellular communications module and a private mobile radio module to communicate with other mobile devices in the group using private radio communications. A roaming manager of each of the mobile devices determines that the mobile device is no longer in communication via the private mobile radio module and responsive to the roaming manager, the private mobile radio module is deactivated and the cellular communications module is activated. Each of the plurality of mobile devices of the group establishes a connection with the server using their cellular communications module, the server providing audio communications for the group.

### RELATED APPLICATION

This application claims the benefit of and priority to U.S. Provisional Application No. 61/439,426, entitled “Systems And Methods For Audio Roaming For Mobile Devices” and filed on Feb. 4, 2011, which is incorporated herein by reference in its entirety.

### FIELD OF THE INVENTION

The present application generally relates to mobile communication devices for outdoor activities. In particular, the present application relates to systems and methods for seamlessly roaming between multiple communication interfaces of a multi-purpose mobile device.

### BACKGROUND

A user or a group of users located in an outdoor environment which may or may not have cellular telephone coverage may wish to communicate with each other via communication devices. The users may wish to establish communication for safety purposes as well as be able to navigate and find each other in case of an emergency. A private radio communication device, such as a walky talky, may enable a group of users to communicate with each other via a radio frequency range. When a user communicates with a group of users via a private radio communication device the user may step outside of the radio signal range and lose contact with the group. This makes communications between users in a group difficult to maintain.

### BRIEF SUMMARY

The present disclosure provides systems and methods for maintaining communications between multiple mobile communication devices by seamlessly switching between a plurality of radio systems, such as a Pulse Modular Radio (PMR) unit and communication networks including the GSM network, GPRS network or internet protocol (IP), such as the voice over IP connections. In a PMR system, when a participant falls out of the reach of the other PMR participants normally this participant cannot continue communication with the others. However, the present disclosure describes systems and methods that enable such a participant to continue the conversation even once the participant has stepped outside of the PMR radio range. The systems and methods described herein provide maintaining the group communication feature in cases in which a participant steps outside of the communication range by “roaming” between PMR and Mobile Networks using devices which are equipped to communicate as both, the PMR radio units as well as the mobile telephone units.

Generally, the present disclosure describes a wireless multi-purpose and multi-function handheld mobile device, herein also interchangeably referred to as a mobile device or a device, may enable a user of a group of users in an outdoor environment to communicate with each other, individually as well as a group. The users may utilize the features of the mobile device to navigate through the outdoor terrain via a personal global positioning system (GPS) functions in addition communicating with other group members via a private radio communication functions, thus using the mobile device as a walky-talky operating over a range of radio frequencies. Mobile device may enable a user to connect to relevant content and social network via a cellular telephone communication functionalities for accessing the internet, such as a general packet radio service (GPRS), enhanced data rates for GSM (EDGE) or the enhanced GPRS (EGPRS), or a wireless local area network (WLAN) technology. Mobile device may also enable a user to communicate freely using radio frequency range, as a private mobile radio (PMR). For example, the users may use the device for private radio communication purposes via channels of a PMR 446 radio frequencies operating at around 446 MHz. The multipurpose and multifunction hand-held mobile device may therefore provide the user with means for navigating through the outdoors as well as for off-net/on net group communication, individual telephone communication, access to the internet and with a range of additional group community services. The device may combine GPS, PMR 446 with GSM, such as GPRS or 3 G communication bearers to provide advanced group communication services on top of a standard open operating based user customizable Smart Phone.

Mobile device may be include a range of applications that are easy to use, such as a magnetic compass, outdoor activity relevant applications, such as group functions for tracking presence and location of other members of a group, as well as additional third party applications. Mobile device may include a camera or a camcorder, a light emitting diode (LED) flash light and a barometer which may be used as a barometric altimeter. Mobile device hand-held device may provide multitude of services to an outdoor enthusiast by enabling the user to use the device as a GPS navigation device, on road as well as in uninhabited areas, such as off-road areas, mountains or deserts. The device may be used by families and friends with serious outdoor sports hobbies, such as skiing, snowboarding, mountain biking, hiking or climbing, camping, caravanning, motorcycling, globetrotting, hunting, fishing, boating or river rafting.

In particular aspects of the present disclosure, a group of users in an outdoor environment may communicate with each other via PMR radio or walky talky functions of the mobile devices which are also equipped with mobile telephone technology. While communicating via the PMR function, such as the private radio, each of the members may also be within the coverage area of a GSM/GPRS mobile network. As one of the participants in the conversation loses the PMR signal with one or more of the group members or falls out of the PMR communication range, the conversation may be transferred from the PMR radio channel to an environment provided via the GSM/GPRS mobile network.

The conversation may also be transferred between the PMR radio channel and any other wireless communication medium, protocol or a connection including a GSM or a GPRS network, Worldwide Interoperability for Microwave Access (WiMAX), Wireless Local Area Network (WLAN) or a voice over internet protocol (VOIP). In some embodiments, the conversation may be transferred from a PMR radio channel to a GSM network via a conference bridge enabling the users to communicate in a half-duplex environment that simulates a PMR radio conversation, rather than a full-duplex telephone conversation. In some embodiments, the conversation may be transferred from a PRM radio channel to a GPRS environment in which the conversation is carried via GPRS data packets. The conversation maybe transferred back and forth between any of the GSM telephony connection, GPRS connection, VOIP and PMR radio channel. In some embodiments, regardless of the connection medium, the conversation may maintain its half-duplex nature in which only a single user may communicate at a time, thus simulating a standard PMR radio conversation. In other embodiments, the conversation may be treated as a full-duplex telephone conference conversation.

As the transfer of the conversation occurs, the users may experience no interruption and may continue their conversation via the GSM/GPRS mobile network. The participant that has fallen out of the PMR communication range may rejoin the conversation with other users within the mobile network provided environment. Once the members of the group are back within the range of the private radio o with respect to each other, the conversation may again be transferred from the GSM/GPRS network to a selected channel of the PMR radio. Participants may then continue their conversation seamlessly on the PMR radio using their mobile devices as walky-talkies and not incurring any additional mobile network charges.

In some aspects, the present solution is directed to a method for seamlessly communicating among a plurality of mobile devices comprising private mobile radio modules. The method includes establishing a group of mobile devices. Each of the mobile devices comprising a cellular communications module and a private mobile radio module to communicate with other mobile devices in the group using private radio communication. The method also includes communicating audio, by a mobile device of the group with one or more mobile devices of the group, using private radio communications via the private mobile radio module. The method also includes determining, by each mobile device of the group, that the mobile device is no longer in communication via the private mobile radio module and deactivating, by each mobile device of the group responsive to the determination, their private mobile radio module and activating their cellular communications module. The method may further include establishing, by each mobile device of the group, a connection with the server using their cellular communications module, the server providing audio communications for the group.

In some embodiments, the method includes establishing, by the server, a telephone conference between the mobile devices of the group. In some embodiments, the method includes simulating, by the server, audio communications between the mobile devices of the group, as occurring via the private module radio modules. In some embodiments, the method includes determining, by the server, that each mobile device of the group is within a predetermined range limit of the private mobile radio module, and responsive to the determination, sends to each mobile device of the group an instruction to establish communications via their private mobile radio modules with the other mobile devices. In some embodiments, the method includes receiving, by each mobile device of the group, information on a number of mobile devices of the group and identification of each mobile device. In some embodiments, the method includes transmitting, by the mobile device, a keep-alive message to each of the other mobiles devices of the group. In some embodiments, the method includes determining, by each of the mobile devices of the group, that the mobile device is outside a predetermined range limit of the private mobile radio module. In some embodiments, the method includes determining, by each mobile device of the group, that the mobile device has lost a signal via the private mobile radio module. In some embodiments, the method includes determining, by each mobile device of the group, that the mobile device is no longer in communication upon not receiving a keep-alive message within a predetermined time period. In some embodiments, the method includes receiving, by the server, group information from one or more of the mobile devices of the group.

In some aspects, the present solution is directed to a system for seamlessly communicating among a plurality of mobile devices comprising a private mobile radio module. The system includes a plurality of mobile devices establishing a group. Each of the plurality of mobile devices comprises a cellular communications module and a private mobile radio module to communicate with other mobile devices in the group using private radio communications. A mobile device of the group in audio communications with one or more mobile devices of the group using private radio communications via the private mobile radio module. A roaming manager of each of the plurality of mobile devices determines that the mobile device is no longer in communication via the private mobile radio module and responsive to the roaming manager, the private mobile radio module is deactivated and the cellular communications module is activated. Each of the plurality of mobile devices of the group establishes a connection with the server using their cellular communications module, the server providing audio communications for the group.

In some embodiments, the server further establishes a telephone conference between the mobile devices of the group. In some embodiments, the server further simulates audio communications between the mobile devices of the group as occurring via the private module radio modules. In some embodiments, the server further determines that each of the mobile devices of the group are within a predetermined range limit of the private mobile radio module, and responsive to their determination, sends to each of the mobile device an instruction to establish communications via their private mobile radio modules. In some embodiments, each mobile device receives information on a number of mobile devices of the group and identification of each mobile device. In some embodiments, the mobile device transmits a keep-alive message to each of the other mobiles devices of the group. In some embodiments, the roaming manager determines that the mobile device is outside a predetermined range limit of the private mobile radio module. In some embodiments, the roaming manager determines that the mobile device has lost a signal via the private mobile radio module. In some embodiments, the roaming manager determines that the mobile device is no longer in communication upon not receiving a keep-alive message within a predetermined time period. In some embodiments, the server receives group information from one or more of the mobile devices of the group.

### BRIEF DESCRIPTION OF THE FIGURES

The foregoing and other objects, aspects, features, and advantages of the invention will become more apparent and better understood by referring to the following description taken in conjunction with the accompanying drawings, in which:

FIG. 1A is a block diagram of a multifunction mobile device, herein also referred to as the mobile device:

FIG. 1B is an embodiment of a design of the mobile device;

FIG. 1C is another embodiment of a design of the mobile device;

FIG. 1D is a block diagram of the hardware components of the mobile device;

FIG. 2A is a block diagram of an embodiment of a firmware/software platform of the mobile device;

FIG. 2B is a block diagram of another embodiment the firmware/software platform;

FIG. 2C is a block diagram of an embodiment mobile device applications;

FIG. 2D is an embodiment of displayed mobile device applications;

FIG. 2E are illustrations of other embodiments of displayed mobile device applications;

FIG. 2F are illustrations of other embodiments of displayed mobile device applications;

FIG. 2G is an embodiment of displayed mobile device applications;

FIG. 2H is an embodiment of displayed mobile device applications;

FIG. 2I is an embodiment of displayed mobile device applications;

FIG. 2J is an embodiment of displayed mobile device applications;

FIG. 2K are illustration of embodiments of displayed mobile device applications;

FIG. 2L is another illustration of an embodiment of displayed mobile device applications;

FIG. 3A is a block diagram of a system for audio roaming between a private radio communication system and a mobile telephone network; and

FIG. 3B is a flow diagram of embodiments of a method for implementing roaming between private radio communication system and a mobile telephone network.

In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:
Section A describes hardware architecture of the multifunction mobile device;
Section B describes software components of the multifunction mobile device; and
Section C describes systems and method for audio roaming between communications interfaces of the multifunction mobile device.

### A. Multifunction Device Hardware Architecture

Prior to discussing the specifics of embodiments of systems and methods of audio roaming via the multi-function mobile device, also referred to as the mobile device 100 or a device 100, it may be helpful to discuss the environments in which this device may be used. The mobile device may be used by any outdoor enthusiast embarking on a trip in an environment in which he or she would like to utilize a rugged mobile telephone for voice and emergency communication, a rugged GPS navigator for identifying location information and a rugged walky talky for off net group communication with other users in the area. The mobile device may be used in any outdoor setting, such as mountains, prairies, deserts, swamps, lakes, woods, jungles or in any uninhabited area. The device may also be used in any weather and by any group of users, individuals or groups, such as families and friends on a camping or a cross-country trip, skiers and snowboarders, motorcyclists and globetrotters. Mobile device may be used in a fishing trip, a hunting trip as well as in boating, sailing and river rafting trips, jungle expeditions and safaris. An outdoorsy person may use the mobile device for a piece of mind and security of knowing that in case of an emergency he or she may, if necessary, have an access to a telephone, a walky talky, a GPS navigation system device, a light source, a device that connects to the internet, a compass or a device that reveals locations of any other users or persons in the area, all provided by a single multipurpose, multifunction handheld device.

The mobile device may provide a user or a group of users located in a remote outdoor setting with a means to communicate with each other. This device may further provide the users with personal GPS navigation functions and ability to locate other members of the group, may enable data connectivity and access to various activity related applications and internet services. In an environment in which the users may not have access to cellular telephone or cellular data coverage, mobile device may provide the users with a means of communication via radio frequencies open for civilian radio communications, such as for example (private mobile radio) PMR 446 operating at around 446 MHz frequency. In some embodiments, radio communication may be implemented via military or government use designated radio frequency ranges. Implementing the communication via the radio band may enable the users to communicate with each other without incurring excessive charges, such as roaming charges, from the mobile telephone service providers.

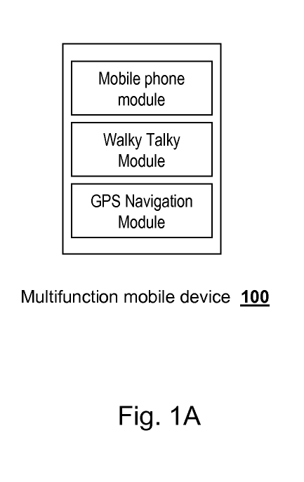

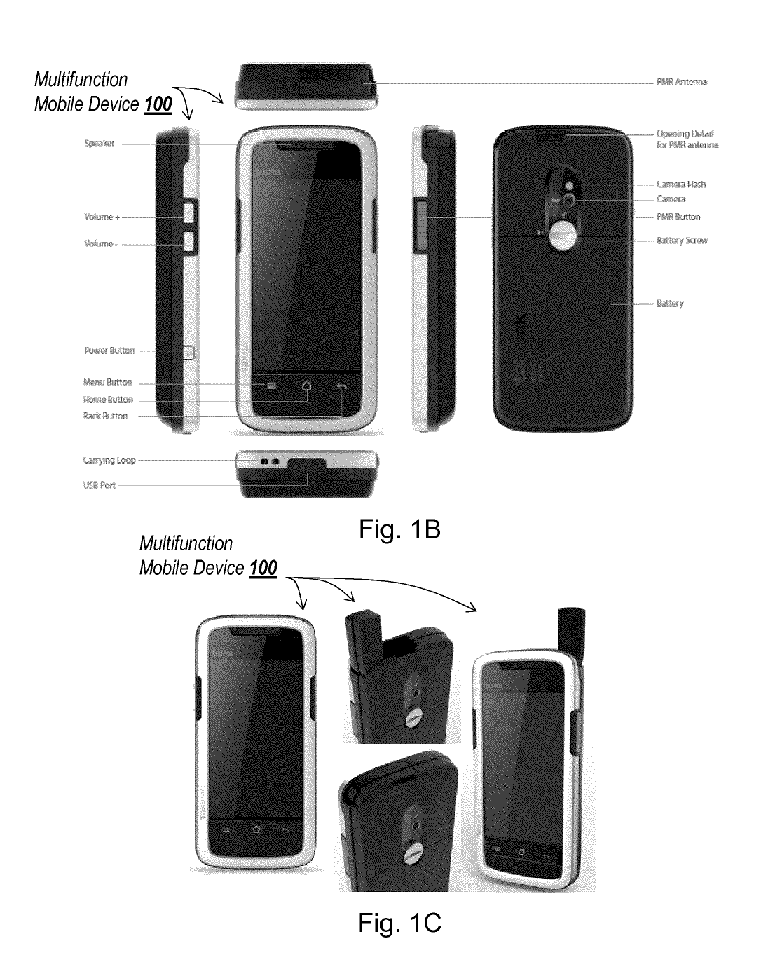

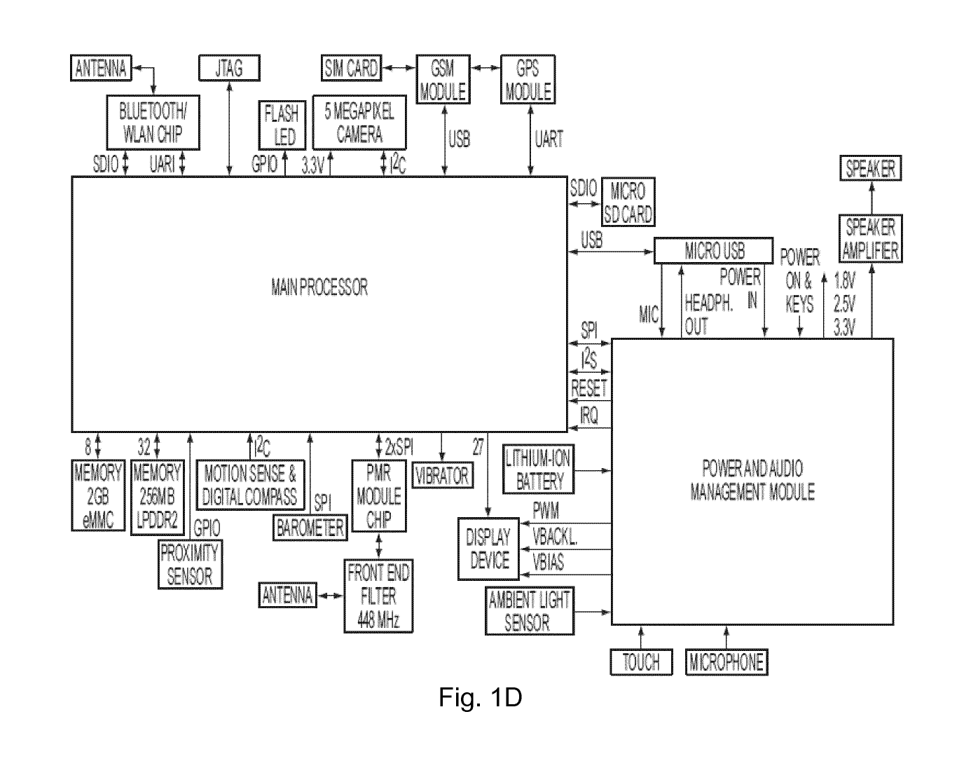

Referring now to FIG. 1A, an embodiment of a block diagram of a multi-function mobile device 100 is illustrated. The mobile device 100, or the device 100, may three main modules, such as the mobile phone module, walky talky module and the GPS navigation module. The device 100 may also include a power button, a display screen and a multitude of other function buttons. Mobile device 100 may be enclosed within a casing or an enclosure which may comprise a hard and rugged material. Display screen may enable the user to user various features of the device and view a graphical user interface. Mobile device may include any features of a portable navigation assistant (PNA) or a portable navigation device (PND). Mobile device may include any functionality of a global positioning system (GPS) device providing location, positioning and directions functions and features to a user. Mobile device may also include any portable hand-held multi-way radio transceiver functionality, such as any functionality of a hand-held walky talky device for communicating via a radio band. Mobile device may further comprise any functionality of a smart phone enabling a user to access the internet, check, send and receive emails or use any other web-based functions.

The enclosure of mobile device 100 may comprise any hard and/or rugged material for protecting the device, including any type and form of a metal, plastic or rubber. The enclosure may include any material or any combination of materials to protect the device from external elements including water, rain, wind, pressure, temperature, tension or compression. The enclosure may provide protection to the hardware components within the device and protect the display screen from any outside elements. The enclosure may enable the device to function upon being dropped, scratched or used in any harsh or stressful environment. Mobile device enclosure may comprise mobile device logo and/or mobile device related information, such as a company name or address. Mobile device enclosure may be compliant with IP57 and MIL-STD 810F/516.6&522 standards and may also be waterproof, such as for up to 1 meter depth under water and for a duration of 30 minutes. The enclosure along with the remainder of the device may be designed to withstand about 8 kV of charge in air and about 4 kV of charge in contact without damage to mobile device 100. Display screen of the mobile device 100 may include any type and form of display as described below.

Mobile device 100 may include any number of selection points, or joysticks which may be used by the user to operate the device. In some embodiments, mobile device includes an on/off button, a volume button, a speaker phone button or a telephone button. Mobile device may include a button to switch between modes of communication, such as the communication via a radio frequency and a communication via a cellular telephone communication or an internet data communication. Any number of function buttons may be included, such as: a docking button, an enter button, a menu button, an escape button, an out button, a go to button, an in button, a navigation button, a search button and a mark button. Mobile device may include any button or a selection feature to enable selection of any functionality or feature of mobile device.

Still referring to FIG. 1A, embodiments of functionalities of the multifunction device may include any number of features useful for a group of enthusiasts in an outdoor environment. A mobile device 100 may combine and include all the functionalities of a cellular telephone, a walky talky device and a hand held GPS navigation device. Mobile device may include any hardware, software or a combination of hardware and software of a mobile telephone device and for implementing mobile telephone functions. Mobile device may also include any hardware, software or a combination of hardware and software of a private radio communication device, such as a walky talky device. In addition, mobile device may also include any hardware, software or a combination of hardware and software of a GPS navigation device. Mobile device may implement any of the functionalities or features of the cellular telephone, walky talky or a GPS navigation device on a single device, thus implementing all of these functionalities on hardware and software of a single device.

Referring now to FIGS. 1B and 1C, embodiments of an industrial design of a mobile device 100 are displayed. In FIG. 1B, the mobile device 100 may be designed to include functionalities of a smart phone, such as a smart phone utilizing Android operating system and software stack for mobile devices developed by Google Inc. In such embodiments, mobile device may include functionalities of an android smart phone in combination with functionalities of an outdoor navigation device and a walky talky device. Mobile device may comprise a speaker and a microphone for communication, one or more volume buttons, a power button, a menu button, a home button, a back up button and a PMR button. Mobile device may also include a carrying loop, a universal serial bus (USB) port, a PMR antenna along with an opening detail for the PMR antenna, a camera flash, a camera, a battery and a battery screw or mechanism for access. Mobile device may include a single antenna for all modules and communication protocols, including PMR, GSM and GPS modules and protocols or may include separate internal antennas for any of the modules.

Mobile device 100 may comprise overall length of anywhere between 10 and 200 mm, such as for example 10 mm, 20 mm, 40 mm, 80 mm, 90 mm, 100 mm, 110 mm, 120 mm 130 mm, 131.60 mm, 140 mm and 200 mm. Mobile device may comprise overall width of anywhere between 10 mm and 150 mm, such as for example 10 mm, 20 mm, 30 mm, 40 mm, 50 mm, 60 mm, 66.50 mm, 70 mm, 80 mm, 90 mm, 100 mm, 120 mm, 150 mm, 200 mm and 300 mm. Mobile device may comprise overall thickness of anywhere between 5 mm and 50 mm, such as for example 5 mm, 10 mm, 15 mm, 20 mm, 20.40 mm, 25 mm, 30 mm, 40 mm and 50 mm. Mobile device may comprise any weight between 50 grams and 500 grams, such as for example 50 grams, 100 grams, 150 grams, 200 grams, 230 grams, 250 grams, 300 grams, 400 grams, 500 grams, 600 grams, 800 grams and 1 kilogram. In some embodiments, mobile device includes dimensions of about 13 centimeters in height, about 7.5 centimeters in width and about 3 centimeters in depth and weighs about 300 grams with battery.

Mobile device 100 may include a resistive touch screen which may enable the user to communicate with the device by touching the features, buttons or options displayed on the screen. The device may also include function keys, such as the home, the menu and back keys of an Android mobile operating system by Google Inc. The volume keys may be used to adjust ringer, cellular telephone calls, such as GSM calls, radio band call, such as the PMR calls when mobile device is used as a walk talky, or even to adjust the volume of media or internet applications, such as audio/video files being displayed on the device. The power key may be used to power up the device and awake the device from the sleep mode. A dedicated PMR key may be used to switch to and from the radio frequency communication mode, or the walky talky mode, which may also be referred to as the PMR mode. Mobile device may include an aluminum frame as well as hard and soft plastic material along with a bumper, a retractable PMR antenna and a cap for the USB port.

Robustness of the mobile device may be according to any international protection rating, including IPx5 or IPx7. Mobile device may be designed to withstand extreme conditions including exposure to water, dust, extreme temperatures, drops, bending, twisting and vibration. Mobile device may be robust to satisfy IPx5 international protection rating or IPx7 international protection rating for protection against outside elements including water, temperature, dust, drops or shocks. In one embodiment, mobile device is water resistant in accordance with IPx5 and IPx7 standards. In a further embodiment, mobile device is dust resistant according to IPx5 standard and/or IPx7 standard. Mobile device may be resistant to a drop test on a concrete floor from a height of 1, 1.5 or 2 meters. Mobile device may also be resistant to stress induced by a barrel testing in which the device is tumbled from 0.5 meters within a turning metal barrel.

Referring to FIG. 1C, an embodiment of a mobile device with a PMR antenna pulled out is displayed. As the device may be switched between the cellular telephone mode and the walky talky or the PMR usage mode, the user may pull out the PMR antenna from the device to improve the reception of the mobile device during the PMR usage.

Referring now to FIG. 1D, an embodiment of a mobile device hardware system is illustrated. Mobile device 100 system may include any number of integrated circuits, processors, memory, logic and computing units. Device 100 may include a central processing unit, also referred to as processor 101. The processor may serve as the main processor for the device and may be integrated with or in communication with any number of other units, functions, devices or modules. Mobile device 100 may also include a module for Global System for Mobile (GSM) and/or General Packet Radio Service (GPRS) communication. Mobile device 100 may further include a module for PMR communication, such as PMR chipset for radio wave communication, such as a walky talky communication. Mobile device 100 may further include a GPS module for GPS navigation and location. Mobile device 100 may further include any number of memory devices, such as a Micro Secure Digital (MicroSD) card interface as well as a Subscriber Identity Module (SIM) card interface, a MicroUSB connector, and memory such as low-power 256 mega byte low power DDR2 memory and 2 giga byte multimedia card (MMC). Power supply module may include a battery, such as Li Ion battery for 2700 mAh and power management circuitry for controlling or managing power, such as a power and audio management integrated circuit (IC). A visual display device, also referred to as display device 124, and may include a touch screen and one or more keys/buttons 126. A power supply, also referred to as power supply 116, may include power management circuitry, a Lithium Ion battery and battery control features. Memory devices may include cache memory interfaced via a bus which may have a faster response time than main memory.

In addition, mobile device 100 may also include a 3.5 inch display with resistive Touch Panel which may be used as display 124 for the device. A combined BT/WLAN chip for Bluetooth (BT) and Wireless Local Area Network (WLAN) communication may be provided as a Bluetooth and WLAN module. A JTAG standard text access port may be included into mobile device 100 for testing purposes. A vibrator module may also be integrated to enable the mobile device to be used on vibration mode similar to the vibration module of a mobile phone activated by a received communication or a phone call. A 5 Mega Pixel (MP) camera with autofocus and a flash light LED may be integrated into the system as well. The camera may include a digital zoom, such as a 3×, 5× or 10× digital zoom. Mobile device 100 may also include modules for a G-Sensor, an electronic compass, an electronic barometer, a barometric altimeter, a proximity sensor and an ambient light sensor. A speaker, such as a loud speaker may be interfaced with an amplifier to provide sufficient dB rating to withstand any loud outdoor environment and enable a user to communicate via a loudspeaker a distance of about 10-100 centimeters from the device.

Still referring to FIG. 1D in a greater detail, the main processor 101, or the central processing unit (CPU) may comprise any hardware or logic circuitry for processing instructions, commands, data, applications or any functionality of the mobile device 100. CPU 101 may include any logic or functionality that responds to and processes instructions fetched from the main memory unit 122 or any instructions pertaining to any functions or user applications. The central processing unit may be provided by a microprocessor. Mobile device 100 may include any mobile telephone, smart phone or any mobile device processor or a CPU that may be used on a mobile device or is capable of operating as described herein.

Memory of the device may include one or more chips capable of storing data. Memory, which may also be referred to as the main memory unit 122, may include static memory and/or dynamic memory. Main memory unit 122 may include functionality to allow any storage location to be directly accessed by the microprocessor 101. Main memory unit 122 may include Read Only Memory (ROM), Erasable Programmable ROM (EPROM), Flash memory (NOR flash as well as NAND flash memory), Electrically Erasable Programmable Read Only Memory (EEPROM). Memory unit 112 may include Static Random Access Memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. The processor 101 communicates with main memory 122 via a system bus. Main Memory unit 122 may also include interface for external, user inserted memory, such as SD-Micro memory card which may be used by the user to add additional memory to the device. In some embodiments, Mobile device 100 supports Micro-SD cards of at least 8 GB in memory.

Memory unit may include memory designated for storing operating system functions, software, data, applications and functions. Operating system may include any type and form of mobile device operating system such as SmartPhone Operating System by Android Inc, Symbian operating system by Symbian Ltd., Microsoft Windows Mobile operating system by Microsoft Corporation, Moblin mobile Linux based open source operating system or any other operating system capable of performing functions described herein. The computing device 100 can be running any operating system such as any of the versions of the Microsoft® Windows operating systems, the different releases of the Unix and Linux operating systems, any version of the Mac OS® for Macintosh computers, any embedded operating system, any real-time operating system, any open source operating system, any proprietary operating system, any operating systems for mobile computing devices, or any other operating system capable of running on the computing device and performing the operations described herein. Software deployed on storage device may include any user selected or downloaded software as well as software or functions implemented by the operating system or mobile device specific functions or applications. Applications 120 may also comprise mobile device specific applications and functions as well as user specific applications or functions described herein.

Power supply module, also referred to as power supply 116, may include a battery and any logic, hardware and software for energy management of the device. The power supply 116 may also include functionality for charging or powering the battery. The power supply may include energy management functionality to adjust the power output so that mobile device's function is optimized with respect to the battery life. For example, power supply 116 may provide the USB ports with about 5V, even in the off state. The power supply may have a limit on the amount of current that may drawn at the same time, such as a limit of about 500 mA. Power supply 116 may comprise any type and form of a battery such as a lithium ion battery, nickel-cadmium battery, silver oxide battery or any other type of a device for storing electrical energy and providing such stored energy to a mobile device, such as the mobile device 100. The battery may act as a power supply for all of the mobile device modules, including the GSM module, PMR module or GPS module. The battery may be charged via a charging or communication interface, such as a USB interface, and may be charged with a charger, such as a standard USB charger. USB interface may include switchable 4-wire universal asynchronous receiver/transmitter (UART) across the USB interface. USB interface may also act as a connector, such as a 10 pin USB Micro-AB socket or cradle connector. For example, UART may be accessible via USB interface. In one embodiment, external rechargeable batteries, such as AA or AAA batteries may be used to power mobile device 100. External batteries along with any additional chargers or mounts may be provided as an additional accessory to the mobile device 100. The power supply 116 may include functionality for power management to ensure that mobile device 100 may have a stand-by time of about 72 hours and about 8 hours of combined usage time. The combined usage time may include about 30 minutes of GSM talk, 30 minutes of PMR talk, 8 hours of GPS turned on and every five minutes group status update in terms of about 20 kb of data via PMR or GSM.

Power Management circuits or functions may provide charging control, temperature control and power supply detection. Safety relevant functions regarding charging protection, temperature control must work independent of the processor or the operating system. In case that the device may not be charged due to the battery's temperature or limitations in the power supply, the device shall be entirely supplied from the power supply, such as the battery may not be drained. Any power management related parameters may be periodically updated to the API at a rate of no more than 10 s. Changes to the external power supply, such as disconnection of a host PC and connection of a charger may be dynamically detected in every power mode, at an update rate of no less than 5 s. When the external charger is connected, the charger may provide to mobile device battery 5V at 1A. The device may be charged from 0% (i.e. below operation threshold) to 100% within 2.5 hours while it is suspended or off and within 3.0 hours, while the device is operated. When the device is connected to a host PC, there may be no charging time requirements if the device is running. If the device is switched off or is in a suspend mode, the battery shall be charged within max. 3.0 hours and the device shall draw no more than 500 mA from the host PC.

Device power management circuitry may include functionality to enable power-up of the device only if the integrity of the system supply voltages are ensured. This may allow for proper selection of a battery voltage threshold used to make the decision whether or not to allow a power-up sequence. In case of an attached external power source, the power management architecture may allow direct supply of the device from that external power source and may support immediate power-up, independent of the battery charging level only, if memory and system integrity can be guaranteed even throughout a sudden power loss. The power management architecture may only allow a device boot-up process if the remaining battery power allows completing a boot-up sequence. In particular, any sequence of cyclic power-up attempts may be avoided. For example, a battery power may allow a boot-up of the device. As the boot-up process starts, the battery voltage may drop below operation level due to the increased operation current, which may cause the device to shut down during boot-up. After shut-down the battery level rises again above operation boot-up threshold and the procedure would start over. This behavior may be avoided via the above mentioned power management function. The operating system may monitor the charging status of the device. Charging of the battery may be limited to a temperature range in order to ensure safe charging and the safety of the device. As such, overcharging protection function may be provided to interrupt the charging process should the battery voltage exceed the voltage limit or should the charging time exceed a time-out value defined in the charging circuitry. Battery power management may include the functions for resetting mobile device 100. A soft reset may reset the processor of mobile device in which data and memory integrity are ensured. Memory caches may be cleared and drivers may be stopped as well as memory controllers. Hardware reset may be done to temporarily disconnect power from all circuitry of the device. A hard reset may be done to bring mobile device settings back to the factory settings.

Display screen or display device 124 may include any type and form of a display device. Display device 124 may be a liquid crystal display (LCD), a light emitting diode (LED) display, an electroluminescent display (ELD), a thin film transistor (TFT) display, an organic light emitting diode (OLED) display, a quantum dot light emitting diode display (QDLED) or a nano-crystal display or any other type and form of display which may be used on the device. Mobile device display may comprise a touch screen that may detect the presence of a location of a touch by a user, thus enabling the user to select features, buttons or points on the display by touching a given section of the display. Display may include any size or resolution, such as HVGA resolution of about 320 by 480 pixels or QVGA resolution of about 320 by 240 pixels. In one embodiment, display 124 includes a trans-flective TFT HVGA display with a contrast ratio of about 300:1, luminance of about 350 cd/m2 and color depth of 16 bits per pixel (bpp). The display may display the user's location, location of other users and a list of users. The display may also display coordinates, direction or a position of the user's location, coordinates, direction or a position of locations of other users or any of the GPS or navigation related functions. The display screen may illustrate the time via a clock, battery related information or any other device related information. The display may provide the user with the graphical user interface as well as enable the user to communicate with the device and to select various functions of the device. Display device may also include a backlight which may be dimmable from 0%-100% in 16 steps of %6.25 each via CPU/Application.

Interfaces for communicating with external network devices may be collectively termed the network interfaces of mobile device. Network interfaces may include any hardware, software or drivers for enabling the mobile device to communicate with a network or another computing device. Network interfaces may also include hardware, software or logic for enabling mobile device to communicate with an external device via a wired or wireless connection, including a USB connection, Bluetooth, WLAN, PMR, GSM/GPRS, GPS or any other communication technique. In some embodiments, network interfaces enable the mobile device to communicate via worldwide interoperability for microwave media (WiMAX) communication protocol. Network interfaces may enable mobile device to send and receive communication via any frequency range and via any communication protocol including: high speed packet access (HSPA), high speed downlink packet access (HSDPA), high speed uplink packet access (HSUPA), evolved high speed packet access (HSPA+) or any other mobile telephone protocol capable of operating as described herein. Furthermore, the network interface may include functionality to interface to a Local Area Network (LAN), Wide Area Network (WAN) or the Internet through a variety of connections including, but not limited to, standard telephone lines, LAN or WAN links (e.g., 802.11, T1, T3, 56 kb, X.25), broadband connections (e.g., ISDN, Frame Relay, ATM), wireless connections, or some combination of any or all of the above. The network interface may comprise or provide functionality for a built-in network adapter, network interface card, PCMCIA network card, card bus network adapter, wireless network adapter, USB network adapter, USB socket, a modem or any other device suitable for interfacing the computing device 100 to any type of network capable of communication and performing the operations described herein. Network interface may include a USB interface for communication with external devices or for charging mobile device battery. USB interface data lines may be switchable between USB mode to support the hardware flow control signals of a 4-wire UART interface including request-to-send (RTS) and clear-to send (CTS) functionality. Switching may be implemented upon detection of a connected device via a pin of a Micro USB socket.

Network interface may include functionality for detecting any external devices being connected to mobile device 100. Network interface may include functionality to respond to the device and establish communication. In one embodiment, network interface includes a USB interface that is designed according to the specifications of the USB Organization. In such an embodiment, when a device signals its presence to a host device by pulling one of the data lines high, the device may record and respond to communication requests of the host. If the device cannot respond to host PC communication requests in time, e.g. during the cold boot process, the initial signaling to the host device must be delayed until the device is ready to respond to the host communication requests. When the device is being suspended while it is connected to a host PC, the device may execute a virtual disconnect, in order to inform the host PC that the device is not able to respond. After resuming from suspend, the device shall inform the host device that the device is available again.

The speaker may be a 2 Watt mono speaker of about 36 mm membrane diameter. Mobile device 100 may further include or be configured with an earpiece, such as a standard earpiece for mobile telephone communication. The speaker may be interfaced with the housing to enable stability and acoustics for efficient output. The frequency range of the speaker may be 500-10000 Hz at −5 dB range. Sound pressure level may be 86 dB measured at 1 m with less than 10% total harmonic distortion across a frequency band of at least 1 kHz in the frequency range between 2 kHz and 4 kHz.

Mobile device may include a microphone for communication in an outdoor and mobile environment. The microphone may be integrated for voice recognition and may be sampled with 16 kHz signal in 16 bit quality of voice recognition. The microphone may be separated and isolated in a rubber enclosure to decouple any low frequency interference and be separated from motherboard electronics, vibrations or noise.

A mobile communication module of the mobile device 100, which may also be referred to as the GSM module, may include any hardware and software to support any standard 2G, 2.5G and/or 3 G communication via GSM, GPRS and/or EDGE protocols. The mobile communication or the GSM module may include customized logic and/or functions. The mobile communication module may also support communication via code division multiple access (CDMA) or time division multiple access (TDMA). The mobile communication module, herein referred to as the GSM module, may include functionality to support high speed downlink packet access (HSDPA) for 3 G communication. GSM module may include adaptive multi rate (AMR-NB) audio codec and multi slot class (MSC) with at least 4 TS downlink and 2TS uplink Pv4 support. GSM module may include functionality to support WiMAX communication. GSM module may also include functionality for enabling the mobile device 100 to communicate with a server, such as the server of a mobile network provider, a proxy server, a cache server or any server or a network device providing access to the internet. In some embodiments, GSM module may comprise functionality to act as a server communicating with other mobile devices 100 via a transport layer protocol, such as the internet protocol (IP).

GPS module may include any hardware and software for location navigation and detection. GPS module may include a receiver which may include wide area augmentation system (WAAS). The GPS module may be differential-ready and may include 12 parallel channels. GPS module may include a power input: 7.2.1, antenna: internal and update rate of 1/second which may be continuously updated. GPS module may include GPS radio frequency (RF) of about 161 dBm sensitivity, which may be front end filtered and provide location accuracy of about 1 meter from the target location. GPS module may also include differential global positioning system capacity along with WAAS functionality. GPS module may be accurate to about 20 meters, 10 meters, 5 meters, 3 meters, 2 meters or 1 meter with about 95% variation with or without any DGPS corrections. GPS module may include velocity accuracy of 0.1 meter/sec at steady state and may have acquisition time of anywhere between 1 second and 60 seconds, such as 3 seconds, 32 seconds and 39 seconds. GPS module may include functionality to provide accuracy of location detection of about 1 meter or in minimum comparable equal or better than best in class competitor device, such as for example navigation system Garmin 550T.

For optimum GPS reception special care may be taken to minimize any unwanted radiation from the device (self interference) to a level which will not degrade the GPS sensitivity, compared to a reference receiver of the same model and make as utilized in the device. Appropriate mass production stable shielding technologies and filtering methods may be applied to the design to ensure that connecting the device to a holder of the user will not degrade GPS performance. In some embodiments, GPS patch-Antenna may include a size of about 25 mm by 25 mm by 2 mm. If GPS receiver works as stand-alone solution (non host based), National Marine Electronics Association (NMEA) signal output may be sent to serial port of CPU. NMEA may include electronic and data specification for communication between GPS devices. GPS module performance in terms of Time To First Fix (TTFF) may be less than 60 seconds for a cold start and less then 5 seconds for a hot start using Mobile Navigator (MN7) application. The ratio of the power level of the signal to the noise conducted or radiated noise generated by the mobile device may be less than 1.0 dB, while device is playing a video (dynamic video content visible on screen) located on the removable memory device and also located on internal flash. The front end of the GPS receiver may include filtering which reduces possible interference from a SIM module or GPRS module which may be attached to the rear docking interface to a level that does not lead to noticeable performance degradation of the GPS receiver, both during acquisition phase as well as during tracking phase.

PMR module may include hardware and software for radio frequency communication. PMR module may include any functionality for implementing two way communication via radio waves, such as walky talky or PMR communication. PMR interface may include hardware or logic for implementing and using two-way radio communication via any frequency range. PMR interface may further comprise an antenna for the PMR communication. PMR interface may include functionality to transmit and receive information at any frequency in the radio frequency range, such as between 30 kHz and 300 GHz. In some embodiments, PMR interface may include functionality to transmit and receive information at frequencies between 1 MHz and 1 GHz, such as for example at any communication channel between 446.00 and 446.20 MHz of the European Private Mobile Radio (PMR) 446 radio frequency range, at any channel between 476.425 and 477.400 MHz of Australian Ultra High Frequency (UHF) Citizen's Band (CB) radio frequency range, at any channel between 462.550 and 467.725 of the General Mobile Radio Service frequency range for the FM UHF radio service in the USA or any other radio frequency range that may be used by a walky talky, a two way radio or any other radio frequency range wireless communication device.

PMR interface may include any logic, hardware, software or firmware to provide the functionality for implementing PMR radio communication and/or Bluetooth wireless communication. Bluetooth functionality may also include non-host CPU based advanced error reduction/noise reduction (AEC/NR) features. PMR module may include any number of channels between 1 and 100, such as for example 8 channels. PMR module may include functionality to communicate via any UHF frequency range, such as at around 446 MHz and may include logic and functionality for communicating via PMR 446. PMR module may include the functionality for squelching unrelated radio communication, such as continuous tone-coded squelch system (CTCSS) codes. In some embodiments, PMR module includes 38 CTCSS codes. PMR module may have a range of anywhere up to 100 km, such as 21 km or 5 km. PMR module may have radio power output of RMR 0.5 W and may have external or internal antenna. PMR module may include functionality for transmitting voice as well as data. Bluetooth functionality may support Bluetooth 2.0 High Speed as well as lower speed communication in addition to supporting WLAN communication. In some embodiments, PMR module and interface include functionality for supporting WiMAX communication of the mobile device with other devices.

Mobile device 100 may operate at any temperature, such as between −10 Celsius and 60 Celsius and may be stored at any temperature between −20 Celsius and 80 Celsius. Mobile device 100 may support GSM/EDGE bands at any number of frequencies, including 850 MHz, 900 MHz, 1800 MHz, 1900 MHz and 2100 MHz. Mobile device may enable communication via PMR radio, a two-way radio or walky talky device, via GMS or WiMAX for any distance range, such as for example 1 km, 2 km, 3 km, 4 km, 5 km, 6 km, 7 km, 8 km, 9 km, 10 km, 11 km, 12 km, 15 km, 20 km, 25 km, 30 km, 50 km, 75 km, 100 km, 150 km, 200 km, 500 km and 1000 km. PMR application may enable the user to communicate to other standard PMR446 Walky Talkies. In some instances, PMR application may enable the user to communicate to any other two way radio or a walky talky regardless of the frequency or channel. In particular the application provides guidance to adjust the channels and other PMR specific settings (like Voice Activation, Voice Scrambling and Roger Beep).

Mobile device 100 may include sensors, indicators, accelerometers, light emitting diodes or devices (LEDs) or buttons. Air pressure sensor may be used as a barometric sensor or barometric altimeter. Barometric altimeter sensor or barometer sensor may comprise any hardware, software or a combination of hardware and software for measuring the pressure of the ambient air and/or determining altitude or height above the sea level. Barometer may comprise functions, algorithms, executables or programs. Barometer may include functionality for measuring air pressure as well as algorithm for calibrating and adjusting the readings for temperature effects.

An accelerometer may be any device measuring acceleration of the device. Accelerometer may be used for display rotation as well as for games. Hall-effect sensor 3-axis may be used for electronic compass. Proximity sensor or ambient light sensor may be used for control touch and display brightness adjustments. Proximity sensor may be used to recognize a user's hand approaching mobile device 100. The range of the sensor may be between 1 and 20 centimeters from the device. The measured distance may be reported via 4 bit linear value to an application programming interface (API). LED flashlight may be of any power and may have any luminescence range of a standard outdoor flashlight, such as between 10 and 100 lumens. Mobile device may include indicators, such as LED indicators which may indicate power state or charging. These indicators may have luminance within 10% of each other, so that they appear even in intensity. Buttons, such as power button may be designed to require a specific amount of force in order to turn on or off the device, to avoid any accidental triggering. In some embodiments, power button may require between 2 and 2.5 N of force, such as 2.2 N, in order to turn on or off the device.

Functionality for minimizing interferences may be provided for speakers and/or microphones in order to improve clarity and efficiency. A high pass filter may be provided having characteristics of electrical audio path such that audio signals below about 300 Hz do not cause strong audible distortions at low. Furthermore, certain properties of the speaker frequency response may require manipulation. The platform may offer means to attenuate those frequencies with minimum of about 12 dB/octave below the (adjustable) cut-off frequency, as well as at least three configurable bandpass or band reject filters, e.g. by means of a codec with equalizer functionality. Filter settings may be made accessible to the customer via API, for means of audio tuning. The hardware and the API may support at least volume settings in steps of 1 unit between 0 (mute) and 100 (Maximum volume setting). The resulting audio volume may be monotonically increasing with increasing steps. The linearization of the volume steps may be done as part of the navigation application by means of a mapping table, which associates each of the 10 volume steps in the application to one of the 101 volume steps in the audio driver.

The device shall support full-duplex handsfree telephony. In order to achieve excellent handsfree audio quality the device shall include echo cancellation and noise reduction techniques. The speaker volume during handsfree conversation may allow conversation at vehicle speeds of 130 km/h in a medium class car, such as a VW Golf 4 on a dry road. In this scenario, the far end party may not hear significant audio artifacts while the other party talks. Besides measures mentioned under paragraphs “Audio input” and “Audio output”, the distance between speaker and microphone inside the housing may be maximized. This shall minimize acoustic coupling between speaker and microphone through the housing volume. The device may include mechanical measures to ensure no audible variations in echo cancellation performance over mass production, e.g. airtight sealing of speaker back volume and sealing of speaker/microphone front against housing to control audio leakage between microphone and speaker. Furthermore, the echo cancellation method and/or the audio attenuation between speaker and microphone may be powerful and precise enough to suppress audible feedback and/or audible artifacts.

### B. Software Platform

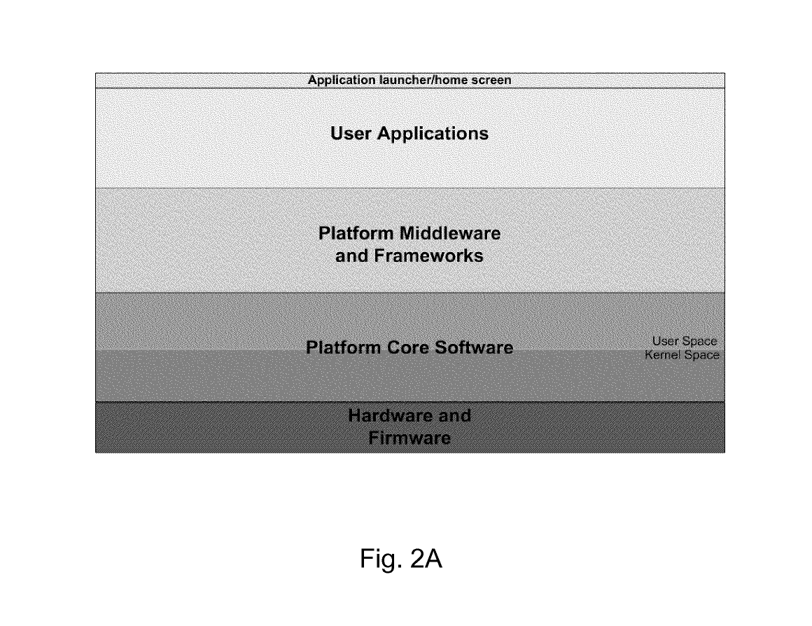

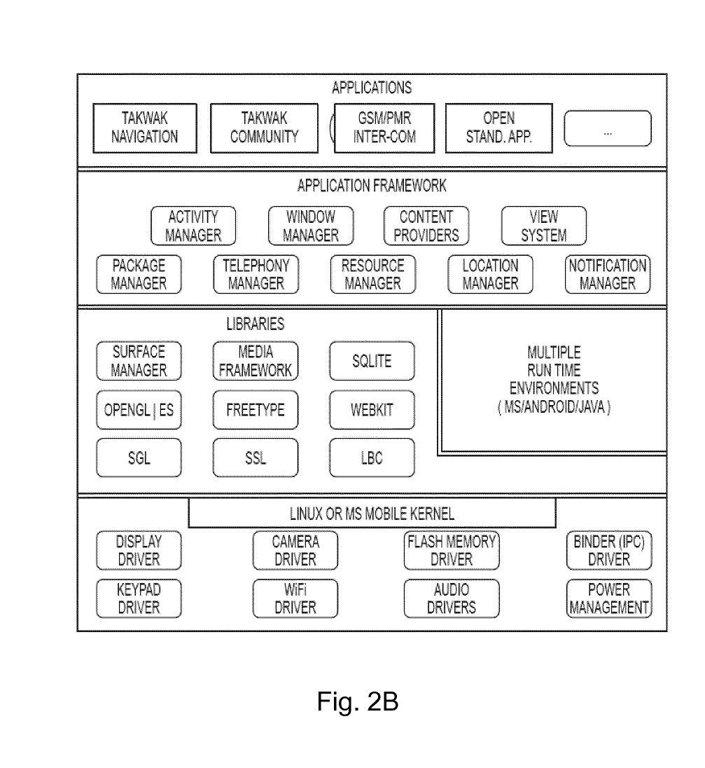

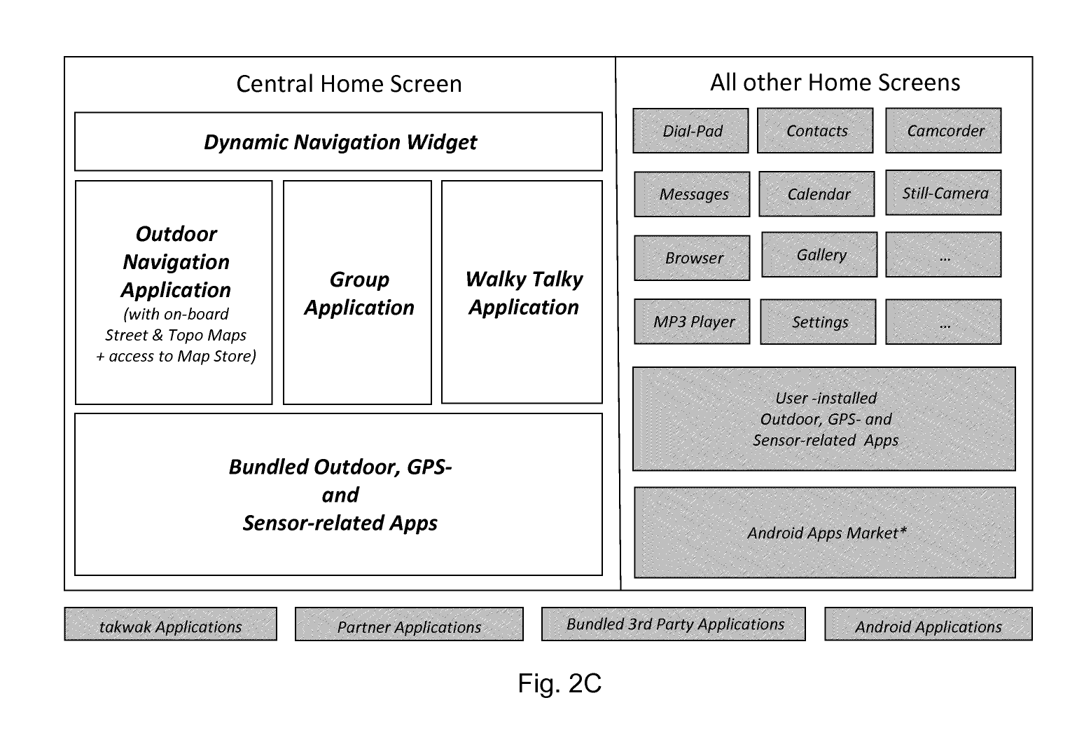

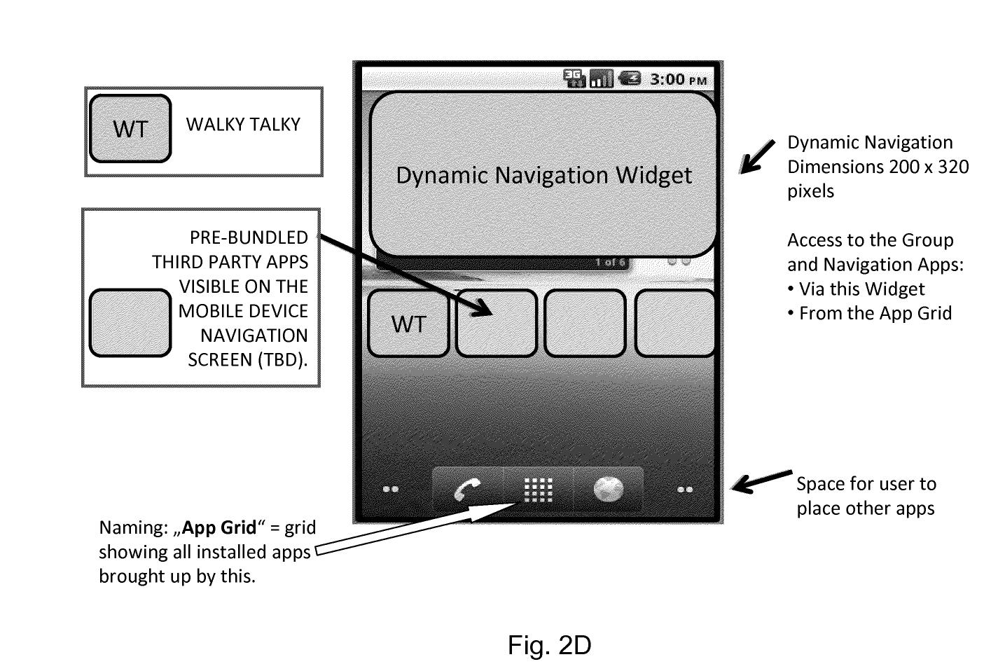

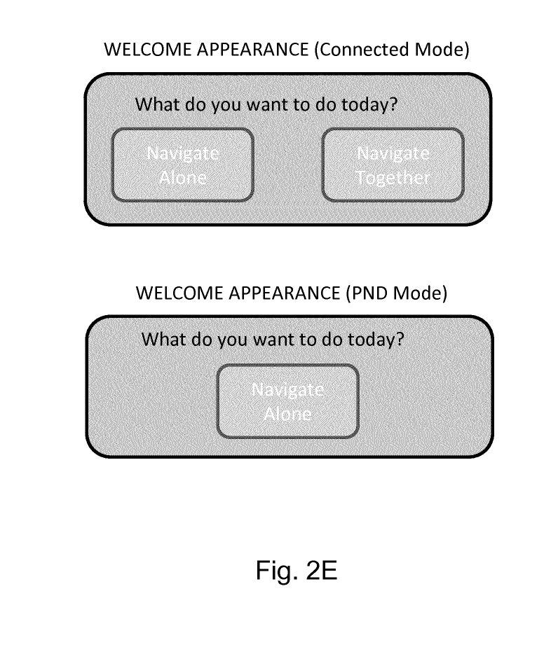

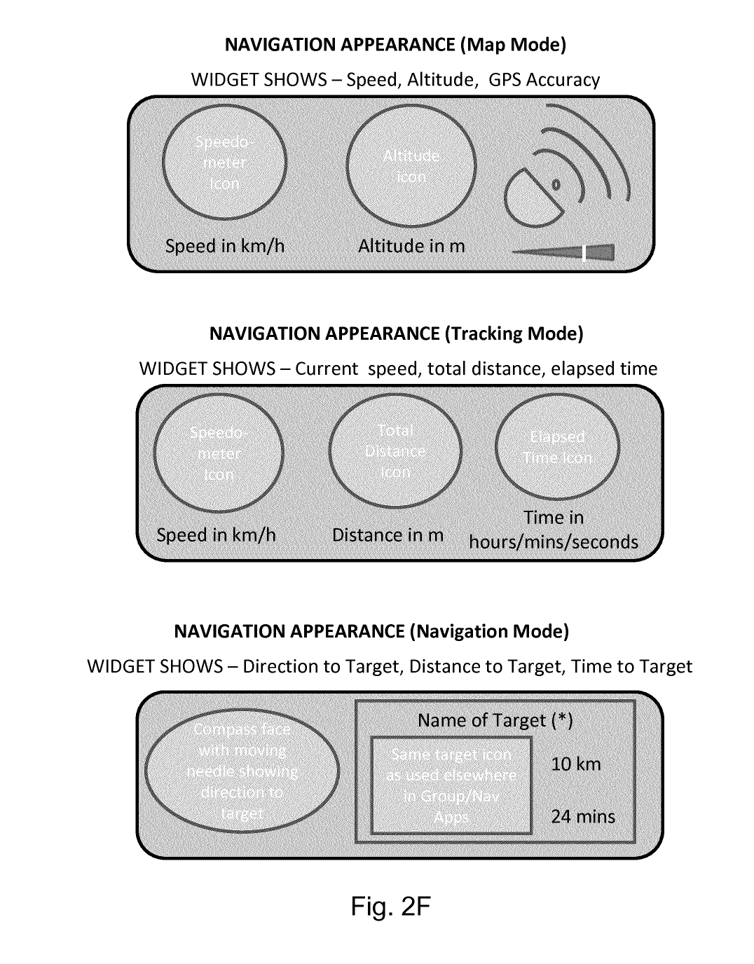

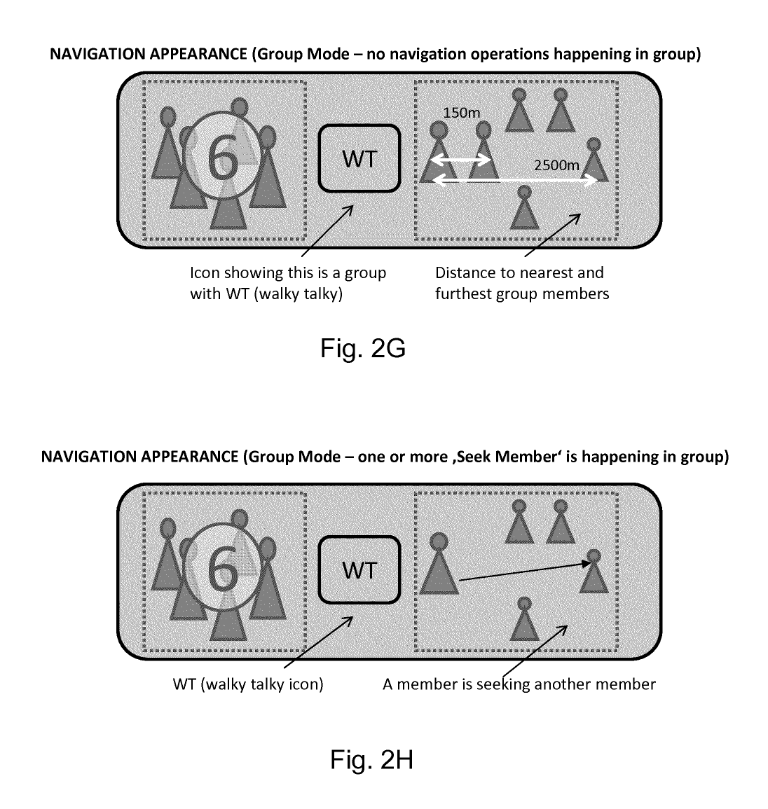

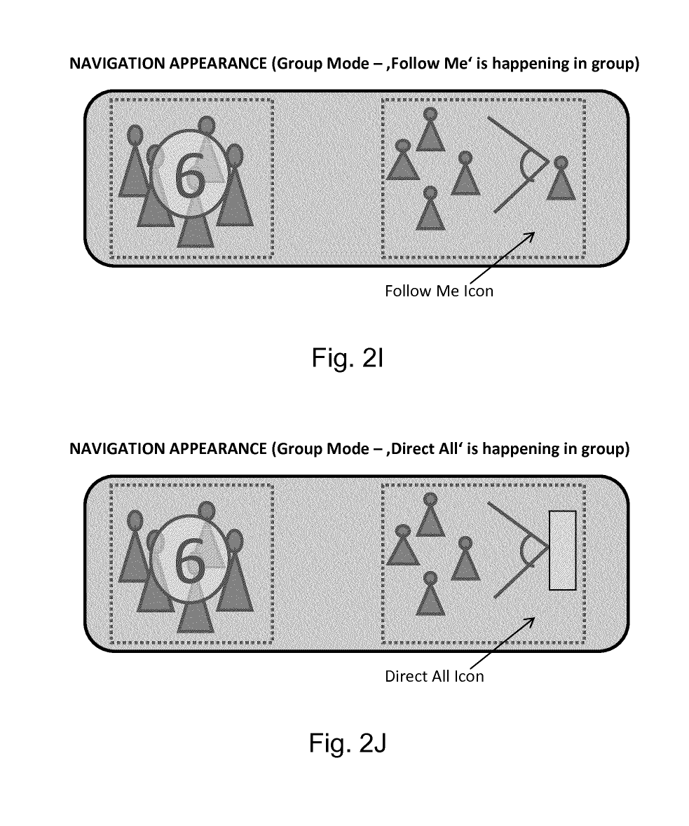

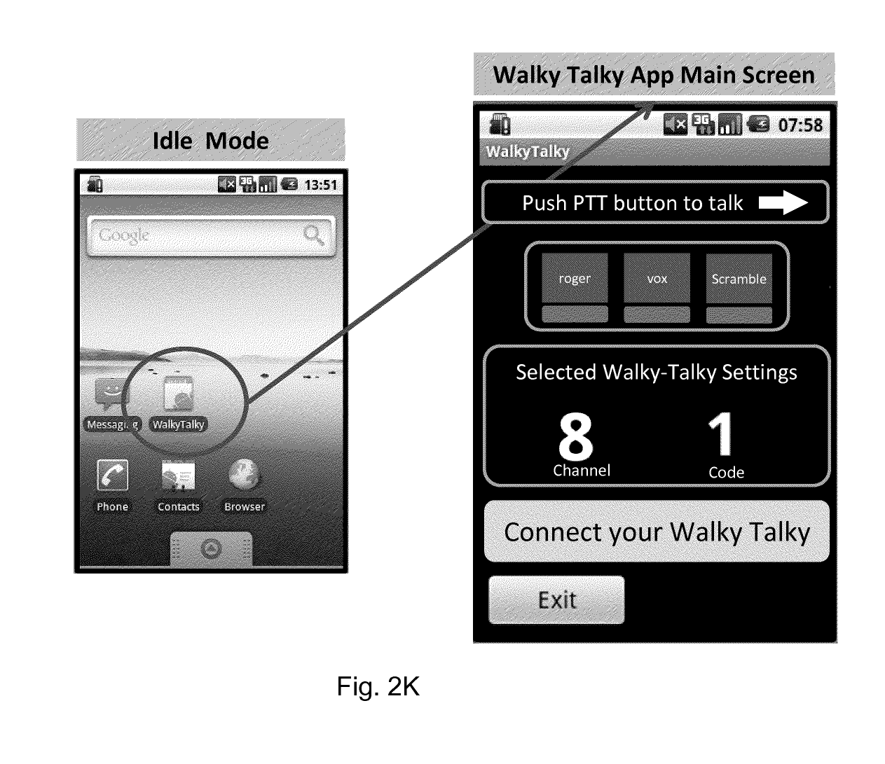

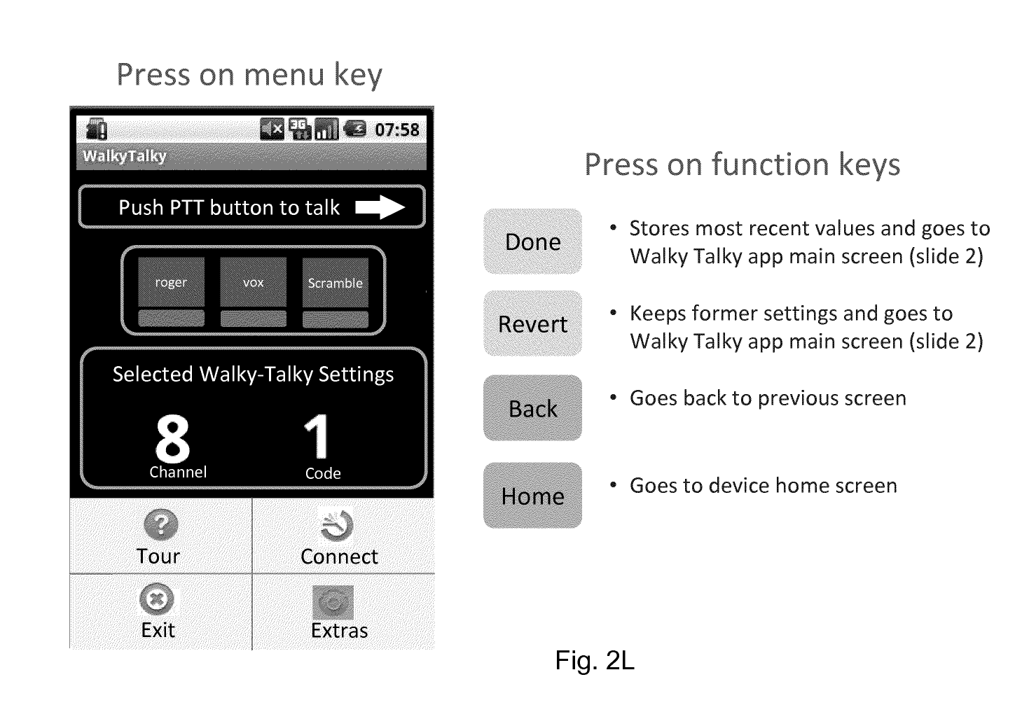

Referring now to FIG. 2A, an abstract overview of a mobile device platform architecture based on a modular operating system is illustrated. The operating system may include any type of mobile operating system, such as a SmartPhone Mobile Operating System by Android Inc. The system architecture may support multitasking applications and services environment. From a broad perspective, the mobile device may include hardware components as described above in connection with FIGS. 1A-1E. The hardware devices may be controlled by fixed firmware programs and data. Firmware programs and functions may include programs, executables or functions which manager and run operations of the hardware enabling the hardware to perform the given functions. Platform core software may execute based on the hardware and firmware and may be divided between the kernel space and user space. Platform middleware and frameworks may operate on top of the platform core software. User applications and application launcher or home screen may execute on the top layers and utilize any of the middleware, frameworks and the platform core software.

Referring now to FIG. 2B, an embodiment of mobile device 100 platform architecture is illustrated. At the lower level Linux or Microsoft Mobile Kernel may host a number of drivers for controlling hardware components or functions. Drivers which may run within the mobile kernel may include: a display driver, a camera driver a flash memory driver a binder (PC) driver, a keypad driver, a WiFi driver, one or more audio drivers and a power management driver. There may be multiple run-time environments operating, such as Microsoft, Android or Java environments. Libraries may include surface manager, media framework, an embedded relational database management system, such as SQlite, a graphics library, such as OpenGL, a font rasterization engine, such as FreeType, a layout engine for web browser to render pages, such as a WebKit, a 3D library for the OpenGL, such as SGL, and a C language library, such as Libc. Application framework may provide framework for running any range of applications, such as: Activity Manager application, Window Manager application, Content Providers application, View System application, Package Manager application, Telephony Manager application, Resource Manager application, Location Manager application and Notification Manager application. Applications, such as Mobile device Navigation, Mobile device Community, GSM/PMR Inter-Com and Open Stand Application may operate on top of the Application Framework.

The platform may also include any number of codecs, such as media codecs, such as AMR-NB audio codec for real-time encoding/decoding, streaming, file format, PCM audio codec for playing and recording, MIDI audio codec, MP3 audio codec, JPEG image codec and MPEG2 video codec. In addition, mobile device may also include any number of other codecs for displaying graphics, audio or video.

Applications may be preinstalled on mobile device 100. Applications may include mobile device settings application, telephone call log application, contacts application, camera application, messaging application, alarm clock application, web browser application, calculator application, music application, calendar application and maps application. In some embodiments, third party applications may be used or installed on mobile device, such as applications for turn by turn navigation for roads and streets, geo-caching applications, such as games, sun and moon information applications, low and high tide information applications, area calculations and others. The Software Application platform and the user interface (UI) may provide access to a community application market to download further applications or to get access to new services. In some embodiments, to enable such access, the device may be binary compatible with other Android Devices. The device with all applications loaded, including the core, mobile device and third party applications may pass the Android Compatibility Test Suite (CTS) as defined in the Android Compatibility website.

On top of the “generic” open OS and standard Software Application/Feature packages which may be able to be used without having the mobile device specific software features and applications implemented/embedded, all other specific software functionality may be implemented by mobile device. Such mobile device specific applications may include: Group Communication application, Group Navigation application and the applications for the use of mobile device as a standard PMR walky talky as well as transmission of data via PMR module.

Referring now to FIG. 2C, an embodiment of mobile device applications along with their home screens is illustrated. In brief overview, a central home screen may include a dynamic navigation widget, an outdoor navigation application, a group application, a walky talky application and a bundled outdoor GPS and sensor related applications. Other home screens may comprise applications such as dialpad, contacts, camcorder, messages, calendar, still-camera, a web browser, gallery, mp3 player, settings or any other additional applications. User-installed outdoor, GPS and sensor related applications and Android market applications may also be installed. In addition, device may further include mobile device applications, partner applications, bundled 3^{rd} party applications and Android applications.

In further overview of FIG. 2C, dynamic navigation widget may include functions, algorithms, programs or interface for navigating through the applications or interfaces of the mobile device. Dynamic navigation widget may include a user interface or any graphical representation of the mobile device functions. Dynamic navigation widget may include functionality to enable a user to interface with the device and scroll through the screens of the device to select the applications or features of interest. Dynamic navigation widget may include links or triggers to functions the user may select. The functions selected may be any functions on the mobile device 100.

Dynamic Navigation Widget may be a widget and may be positioned on the central home screen of the mobile device and it may display most updated or actual status information from the Outdoor Navigation and Group Applications. The information displayed within the Dynamic Navigation Widget may depend on the current usage mode (such as, navigating alone or in a group), the Outdoor Navigation operation in progress (such as, recording a track, navigating to a target) and the group navigation mode selected (such as, seek member, follow me, direct all).

Outdoor navigation application may include functions, programs, algorithms and interface for using and displaying GPS navigation. Outdoor navigation application may include GPS navigation features and functions and may operate using the GPS module and its functionalities. Outdoor navigation application may include libraries of maps, coordinates and sites information. Street and topographic maps may be stored in memory and additional maps may be purchased through online stores for mobile device applications. Outdoor navigation application may include functionality and features to inform the user of the user's present location via coordinates. In addition, the application may provide the user with information regarding the user's altitude. Outdoor navigation information may further include functions for monitoring and updating weather information and weather forecast. Outdoor navigation information may enable the user to track coordinates or movements of other mobile device users, such as for example the members of the group. Using this application, the user may monitor locations and movements of other users or group members in the area. The Outdoor Navigation Application may include any functionality of the Scout application for iPhone made by MagicMaps, with the notable addition that the Open Street Map (OSM) base map data are stored onboard the device. Maps User may select between Open Street Map (OSM) and topographical maps. Maps may be stored locally on the device and may be available regardless of connectivity. User can install/de-install hundreds of OSM regions for the whole world at will (OSM map material is free of charge). User may get one free top( ) map from MagicMaps and can buy more on demand. Purchasable top( ) maps may cover a region of any size, such as for example 200 kilometers squared. Outdoor navigation to a target may be supported by graphical instructions or spoken instructions. A user can customize the displayed data such as speed, distance, average speed using a Tacho functionality. The user may track himself (track is stored in tours). The user can download tours from others (commercial or community content) using Tours functionality. Tours can be rated and provided with further attributes (suited for, scenery, etc).

Group application may include functions, programs, algorithms and interface for providing means for monitoring, tracking and maintaining contact with other members of the group. Should the user using mobile device be a member of a group of mobile device users in the surrounding area, the user may use the group application to maintain contact with the members of the group, to gather information about their presence and movements and to share information with other members. Group application enables the users to freely roam an area, such as woods or a jungle, being able to stay in contact with any other member or with the group as a whole. Group application may include information and links to any of the members of the group, enabling the user to select the user should a phone call or a walky talky communication be needed. The user may also acquire coordinates or view a map of a location of any of the users, thus enabling the user to find the remaining members of the group, should it be necessary. Group application may be interfaced with other applications. For example, a user may select another member of the same group and view the location of the other member using the outdoor navigation application or establish a contact with the member using the walky talky PMR radio communication.

Group application may be an application that allows forming groups with owners of other mobile devices and following their location and presence on the map of the Outdoor Navigation Application. Such location and presence data may be transported via the GPRS/EDGE network and a dedicated mobile device Group Server. The application may provide various navigation options. One such option may be a Seek Member option in which one or more members of the group wish to follow another member. Another option is a follow me option in which all members are invited to follow one member. Another option is a direct all option in which all members are invited to be directed to one joint target. In addition, the Group Members can communicate to each other via the PMR functionality and can instantly share objects like instant messages, photos, sound recordings and tracks with individual group members or with the whole group.

Walky talky applications may include functions, programs, algorithms and interface for communicating via radio frequencies. Walky talky applications may utilize PMR module to establish communication and data transmission with other mobile device users via radio frequencies, including the PMR dedicated frequencies and channels described above. Walky talky application may enable the user to talk to other users using a channel which may be accessible to all the users in the area. In some embodiments, the channel may be accessible only to the two users communicating. Walky talky application may be used for transmitting data or information between two mobile devices. The data or information may include any information or data described herein, including the GPS coordinates of users and data of any applications or functions described herein.

In some embodiments, information about the coordinates or location and presence data for the GPS navigation applications among members is transmitted via digital PMR. In some embodiments, information about GPS coordinates or location and presence data may be transmitted via GPRS/EDGE and/or the mobile device Group server. In such embodiments, users operate the Group application in areas without cellular network coverage (and free of charge). Voice communication via mobile device Group server (push over cellular technology) may allow the users to have voice communication with their group members over longer distance than what is enabled by PMR (data transport cost is incurred for group communication).

Bundled applications may include any collection or group of applications for the user, including applications for sensors, such as the barometer, barometric altimeter, compass, accelerometer, and proximity sensor. These applications may enable the user to access applications for configuring or setting these sensors. In some embodiments, the user may use one of the bundled outdoor applications to access an application for the barometer or the barometric altimeter. In some embodiments, the user accesses a compass application in order to use a compass for orientation and navigation purposes.

Barometric altimeter application may be used for determining a height above the sea level, such as for example in mountain climbing expeditions. A barometer sensor of mobile device 100 may be interfaced with a sensor manager which may process the signal from the sensor. Sensor manager may convert the barometer sensor input signal into a signal that may be proportional to pressure on a pressure scale such as Pascal. The barometer may be calibrated for pressure and temperature. The barometer may be calibrated to compensate for any variations in reading due to change in temperature. As such there may be adjustments made to barometer or to the altimetric measurements based on the ambient temperature of mobile device and this change may be implemented in the system and unnoticed by the applications. Thus, a navigation application displaying the location coordinates and the altitude may use most correct of the barometer or the GPS altitude data to determine the altitude of the user carrying the mobile device. In some embodiments, mobile device may determine the barometer readings based on the more correct of the GPS altitude data or the barometer sensor.

Barometric altimeter may be calibrated or zeroed in order to more accurately perform measurements. Barometer may provide more correct measurement than the GPS signal as GPS altitude value may invariably jump with a greater degree of error. This reading may be stabilized using the barometer sensor and an application that uses the barometric reading to determine the latitude rather than reading from the GPS signal's estimation of altitude. The application may determine the latitude using the barometric sensor readings. However, the barometer may be zeroed based on some recent valid GPS data. In one embodiment, an algorithm continuously monitors GPS precision with sliding time window. If GPS error remains below a specific threshold for error percentage for a predetermined duration of time, the algorithm may use the GPS barometric value to zero the altimeter with average value altitude reading over this time. For example, if GPS error remains below an error percentage threshold, such as below 1% for a duration of 30 seconds, the algorithm may average the GPS barometric value and zero the barometric altimeter reading using this value. Zeroing may entail replacing the previous value of the barometer sensor with the new value. Using this method, in instances in which the GPS readings have low error percentage the barometric altimeter readings may be more accurately determined. Alternatively, in some embodiments, more accurate barometric readings may be determined using GPS altitude data for low error GPS readings using the same or a similar algorithm.

As such a GPS unit may receive a barometer related reading using GPS altitude precision and the algorithm may use this altitude to determine or estimate the barometric reading. However, should GPS module detect a low error reading for a duration of time, barometric sensor may be zeroed with the GPS reading and applications may use the new value for the barometric readings. As such, the GPS navigation application, such as LocationProvider may use the most correct barometric reading, whether that be from the barometric sensor device or the GPS altitude signal.

In some embodiments, a user may know his or her precise altitude and may use that value to correct the altitude value on the system. The user may have an independent barometer and may use the read value to update mobile device system. In that case the user may input the barometric reading and mobile device may calculate the most correct altitude. Mobile device may then use this altitude for determining future changes in altitude. Alternatively, the user may enter the altitude using more accurate GPS coordinates. Mobile device may determine the barometric value from this input. In some embodiments, a server containing an elevation model may update the mobile device with the latest elevation values. In some embodiments, when a user explicitly zeros the altimeter, automatic zeroing based on good GPS data may be suspended for a duration of time, such as for example two hours, three hours, four hours or five hours.

A compass application may be used to determine the accurate direction to true north from a magnetic sensor's output. A 3 axial magnetic field, strength values adjustments may be made for the orientation of the device in the gravitational field and the delta between the magnetic and true north at the present location. For the orientation of the device in the gravitational field an input from a g-sensor may be used. To determine the delta between the magnetic and true north at the present location information from GPS and/or a model of the globe may be used. Android system may include a legacy Sensor Type which may implement the G-sensor adjustment, to the return magnetic north. In some embodiments, this feature may be used by the Mobile device apps. In some embodiments, deviation between the magnetic north and the true north may be ignored. However, the magnetic north to true north difference may be very small, such as under 10 degrees in some regions. As showing north may not require high accuracy for some applications, magnetic north may be used as the true north.

An electronic compass may get influenced by magnetic fields in the environment, such as near machines or cars. Often this may affect the readings of the magnetic field sensor. This fixed offset can be calibrated out by using the sensor in a special mode (self-test mode) and getting the user to move the device in a certain way (e.g. figure of 8, rotate around 2 or 3 axes). In some embodiments, when a user notices the compass is not correctly calibrated (e.g. not in line with user's knowledge where north is), they are given the option to initiate calibration. This option may be added to the settings core application. The exact method of calibration may depend on the type of compass and the system.

Other home screens may include applications for user specific communication, such as dial pad for dialing a mobile telephone number or contacts for selecting the telephone number from an electronic phone book. Messages application may be used for SMS or MMS messages to another mobile phone. Camcorder or a still-camera may be used for taking photos or videos from the area. Gallery and MP3 player may be used for playing or viewing multimedia files, such as audio or video files. User installed outdoor, GPS and sensor-related applications may include any outdoor applications which may be used for GPS or sensors of mobile device, such as for example additional maps, additional interfaces for compass or barometric altimeter. The user may also gain access to Android applications market to download any additional applications from an application store.

Mobile device applications, partner application, bundled third party applications and android applications may include any additional software applications which may be used on mobile device. In some embodiments, third party applications may be used, such as for example Android applications from 3rd party developers that may be pre-bundled. Such applications may include solutions for specific activities or outdoor related interest, like skiing maps, snow & weather report, sports related applications with connection to heart rate belts connected by Bluetooth, etc. Furthermore the user can download (free or commercial) Android applications serving his needs from Google's Android Market or other marketplace for Android applications like Androidpit or Handango.

FIGS. 2D-2L present example embodiments of user interfaces displayed on the mobile device as the user utilizes the functions and applications of the mobile device 100, such as any of the navigation functions. In reference to FIG. 2D, an embodiment of a Dynamic Navigation Widget displayed on the display screen of the mobile device is illustrated. Walky talky application link is displayed on the screen and additional spaces for other pre-bundled third party applications are displayed as well. Dynamic navigation widget may be displayed in a screen of about 200 by 300 pixels and may provide access to the group and navigation applications. Similarly, application grid may also provide access to the group and navigation applications.

Referring now to FIG. 2E, two embodiments of welcome appearances are illustrated. A connected mode welcome appearance may be used for a user who is a member of a group of mobile device users. The user may be prompted to either navigate alone or navigate together with the group. Connected mode may involve inserting the SIM card into mobile device and having valid GPRS settings. In another embodiment, a user who is not a member of a group may be prompted to navigate alone. PND mode, or the individual mode of navigation, may involve no SIM card inserted and may be used when the user selects flight mode or PND mode from the profile.

Referring now to FIG. 2F, three embodiments of navigation appearance as displayed on the display screen of the mobile device are illustrated. In the map mode, the screen may display speedometer icon along with speed in km/s, an altitude icon along with altitude in meters and the GPS signal icon along with GPS error percentage or other indicator of GPS accuracy. In the tracking mode, the screen may display the speedometer icon and the speed in km/s along with the total distance along with distance in meters and the elapsed time along with time in hours, minutes and seconds. In the navigation mode, the screen may display the compass face with moving needle showing direction to the target along with the name of the target and the distance from the target as well as the time to the target. The screen may also display the target icon as used elsewhere in the group and navigation applications.

Referring now to FIGS. 2G-J, embodiments of dynamic navigation widget navigation appearance are illustrated. In FIG. 2G, an embodiment of a dynamic navigation widget of a group mode display having no navigation operations is illustrated. In FIG. 2H, an embodiment of a dynamic navigation widget of a group mode display in which a “seek member” operation is in operation is illustrated. In FIG. 2I, an embodiment of a dynamic navigation widget of a group mode display having “follow me” operation is illustrated. In FIG. 2J, an embodiment of a dynamic navigation widget of a group mode display having “direct all” operation is illustrated.

Referring now to FIG. 2K, an embodiment of a mobile device display and selection of a walky talky application is illustrated. Display screen may display any number of applications, such as the messaging application, walky talky application, phone application, contacts application, a browser application or any other application described herein. Once the user selects a walky talky application, a new screen will be displayed. The walky talky screen may provide various walky talky commands, such as “roger”, “vox” and “scramble” along with a button to push for communication. Walky talky application may also provide the channel and code for communication. The channel may determine the channel via which a call will be made and the code may be an encryption code. The user may select “connect your walky talky” and upon completion of the conversation the user may select “exit” button.

Referring now to FIG. 2L, another embodiment of a walky talky display screen is illustrated. In addition to previously discussed buttons and options, the user may also select “tour”, “connect”, “extras” and “exit” button. The function keys provided may include “done”, “revert”, “back” and “home”. Done key may lead to the stored values and go to walky talky application main screen. Revert key may lead to former settings kept and also go to walky talky application main screen. Back button may lead to a previous screen, while the home button may lead to the home screen.

### C. Multi-Function Device Intercommunication Interface Audio Roaming

When a group of mobile device users establish an audio interaction via a private radio connection, such as a PMR walky talky communication, each user may normally be within a specific distance range from other users in order to send and receive communications with the group. Should one of the participants in the conversation step out of the private radio communication range, such user would normally no longer be able to maintain the audio communication with other users due to the PMR radio limited range. However, systems and methods may be employed to maintain the audio conversation despite the user being out of the range by transporting the audio conversation from the PMR radio communication system to an environment provided via GSM/GPRS mobile network. For example, should a user step out of the PMR range, systems and methods described herein may be implemented to enable this user to maintain the audio communication with other members of the group as the audio communication is transported or switched from the PMR radio system to other available communication mediums, networks or protocols, such as a GSM or GPRS network, a WiMAX network, a WLAN network or via VOIP over an IP connection via the internet. A server may provide for each of the users, including the user outside of the PMR radio range, an environment in which the users may continue their audio communication. The server may establish an internet protocol (IP) connection with the mobile device of each of the users and may instruct the mobile devices to switch from the PMR radio communication to the GSM or GPRS network, or from the PMR radio communication to VOIP. The server may manage a technique for determining whether the users are back within the range. The server may also trigger the conversation to transfer between any of the GMS, GPRS and VOIP as necessary. Should the server determine that all of the users are again within the PMR radio communication range of each of the other users, the server may transport the audio communication back to the PMR radio.

In traditional walky-talky systems, when a participant steps out of the range of other walky-talky participants, this participant loses the signal and is disabled from communicating with other participants until he or she steps back within the range. The systems and methods described herein enable such a participant to maintain the communication with other participants despite being out of the PMR radio range. In such cases, the audio communication between the users may “roam” from the PMR radio communication system to the mobile network system and may resume via other communication networks or mediums, such as GSM, GPRS, VOIP, WiMAX, WLAN or any other network communication medium as supervised by a server.

In one example, a group of members scattered through an outdoor area are engaged in an audio communication via PMR radio modules of their mobile devices. Each mobile device may be assigned an identifier uniquely identifying the device, and thus the member using the device 100. Mobile devices 100 may be within the mobile network coverage and may be equipped with the GSM or GPRS mobile telephone modules in addition to the PMR radio communication modules. Each member may also be within an access range to a server which may provide and manage group communication with each of the members via the internet protocol (IP). Each mobile device may further be equipped with a function enabling and managing roaming between the GPS/GPRS network and the PMR radio communication systems. The function may enable the mobile devices to be aware of the number of group members and the identifiers of each of the members of the group. As the members may all be within private radio reach and able to broadcast voice bursts to each other, the group integrity may be maintained by exchanging predefined keep-alive broadcasts at regular time intervals via the currently active/chosen radio interface. The keep-alive broadcasts may ensure that each of the members is present and that no members are “lost” or out of the range.

Should one participants fall out of PMR radio communication range, mobile devices of the other members may become aware that the participant is missing. For example, the mobile devices may determine that a member is missing by identifying that a keep-alive broadcast message was not received from one of the members. Similarly, the mobile device of the missing participant may note that no new update messages are received from other group members or that the communication or signal is down. All the members, including the lost member, may activate their GSM modules. The PMR radio modules may be deactivated. In some embodiments, the activation and deactivation of the modules may be implemented automatically and may be triggered by the server or by another mobile device. The members, including the missing member, may establish a connection to the server via any connection, such as a voice telephony, GSM connection, an IP connection maintained over a GPRS backbone or via any communication protocol, such as VOIP. After the connection is established, the members may communicate their member and group information to the server. The server may then provide additional instructions to each of the mobile devices and the mobile devices may follow the server instructions to enable the conversation to be continued via the server. The server may instruct the mobile devices to wait in a virtual “meet-me” room on the server. The meet-me room may enable the members of the group to perform one way audio communication with each other in a similar fashion to the walky-talky/PMR private radio. The server may be made aware of the total group size and the group ID. The audio communication between the users may be roamed, as needed or convenient, between any of the GSM, GPRS, VOIP or any other communication protocol or technique.

After a period of time, the server may advise all mobile devices to temporarily activate their PMR radio modules. The server may use a scheme by which, in an ordered manner, the mobile device of each group member may broadcast its own heartbeat, while other mobile devices listen. Each mobile device may then report to the server the observed heartbeats from other mobile devices along with its own personal identifier and the signal strength of the observed heartbeat of other members. Should the server determine, based on the received reports from each of the mobile devices, that all of the members are within the PMR radio range of each other, the server may request each member to conduct a channel scan and provide the results to the server. The server may then choose the most appropriate channel and instruct all mobile devices of the group to select the particular channel and to switch to the selected channel of the PMR radio. Each member may turn off the GSM/GPRS connection and seamlessly resume their audio communication via the selected channel of the PMR radio system.

In some embodiments, if the server does not detect all group members, the server may decide not to transport the audio communication from the meet-me room to the PMR radio, but rather to wait and remain on the server. The server may also decide to maintain the communication in the meet-me room for a longer period of time should all the members not be in the private radio reach of each other. Alternatively, should all members still not be detected and should all members still not be within a PMR reach of each other, the server may nonetheless instruct the mobile devices of the members in the meet-me room to return to the PMR radio mode. The server may then instruct the mobile devices to meet again back at the meet-me room of the server at a later time and check if the missing member has appeared. The server may also keep checking if the missing member had contacted the server or has accessed the meet-me room, and based on such a determination request the remaining users to return to the meet-me room. This process may be performed with diminishing frequency until a base interval has been reached. It may continue until the lost member is found or the group members decide to deactivate this feature.

In one example, a group of mobile devices communicating via a PMR radio channel determines that a first mobile device of the group has lost the PMR radio signal or is about to lose the PMR radio signal. The mobile devices of the users participating in the audio communication may determine that the first mobile device has stepped outside of the PMR radio range or that the PMR radio signal of the first user is no longer stable or sufficiently strong. The mobile devices of the group may then initiate a function by which the GSM modules of the mobile devices of the users get activated. Each of the mobile devices may connect to a conference bridge or an audio teleconference via GSM. Once the audio teleconference is established, the audio communication previously held via the PMR radio may be seamlessly transferred to the audio teleconference and each of the users may communicate via the GSM. The audio teleconference may be configured as a half-duplex communication, thus enabling a single user to speak at a time, just like with the PMR radio. The first mobile device being within the GSM coverage may also join the audio teleconference. After a while as mobile devices of the users determine that all the users of the group are within the PMR radio range of each other, the audio communication may be seamlessly transferred back to a new selected PMR radio channel and the conversation may resume on the PMR radio.

In another example, upon determining that a first mobile device of the group has lost or is about to lose the PMR radio signal, the group of mobile devices communicating via a PMR radio channel may use a GPRS network to maintain their audio communication. The mobile devices of the group may initiate a function by which the mobile devices connect via a GPRS to a “meet-me” room environment established on a server on a network. Once the “meet-me” room environment is established, the audio communication previously held via the PMR radio may be seamlessly transferred to the “meet-me” room and each of the users may resume the audio communication via the GPRS. The audio teleconference may be configured as a half-duplex communication, thus enabling a single user to speak at a time, just like with the PMR radio. The first mobile device that has lost the PMR radio signal may be within the GPRS coverage may also join the “meet-me” room and may participate in the audio communication. Once the mobile devices determine that all the users of the group are within the PMR radio range of each other again, the audio communication may be seamlessly transferred back to a new PMR radio channel.

In yet another example, upon determining that a first mobile device of a group of mobile devices has lost or is about to lose the PMR radio signal, the group of mobile devices communicating via a PMR radio channel may use a voice over IP (VOIP) as a means to maintain their ongoing audio communication. The mobile devices of the group may initiate a function by which the mobile devices of the users connect via IP to a “meet-me” room environment established on a server on a network. In one embodiment, the users may communicate via VOIP using GPRS as a backbone. Once the “meet-me” room environment is established, the audio communication previously held via the PMR radio may be seamlessly transferred to the “meet-me” room and each of the users may resume the audio communication via VOIP. The audio teleconference may be configured as a half-duplex communication, thus enabling a single user to speak at a time, just like with the PMR radio. The first mobile device may also use VOIP to join the “meet-me” room and may participate in the audio communication. After a while as mobile devices of the group determine that all the users of the group are within the PMR radio range of each other once again, the audio communication may be seamlessly transferred back to a new selected PMR radio channel and the conversation may resume on the PMR radio.

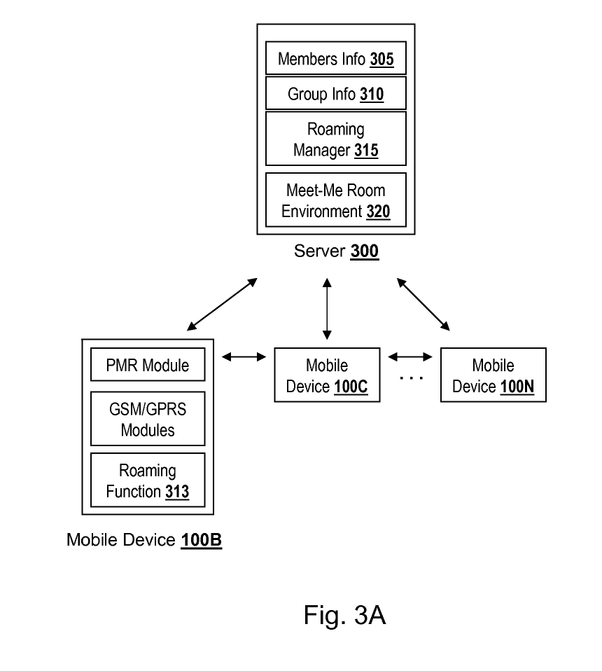

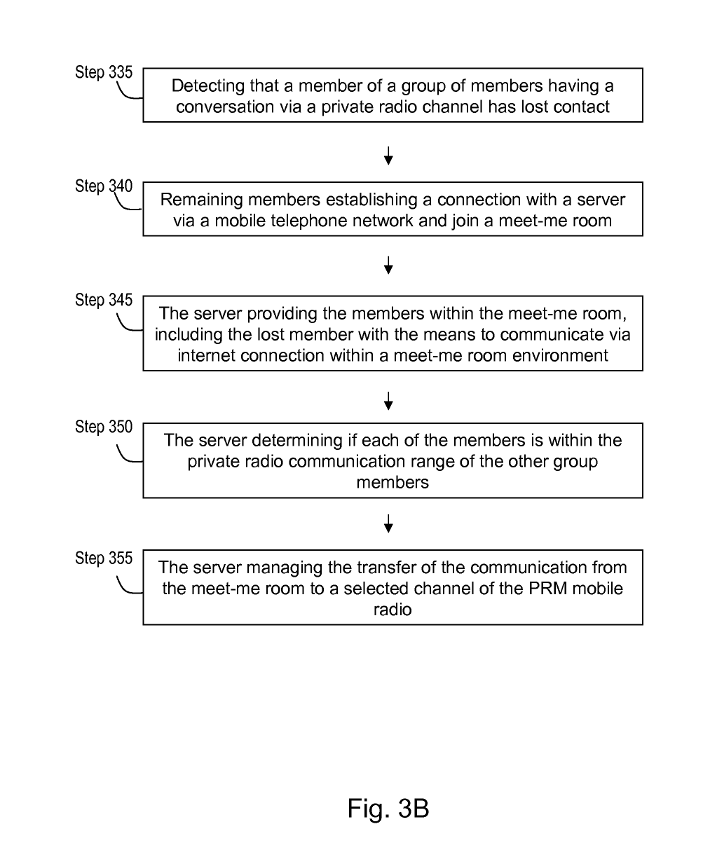

Referring now to FIG. 3A, an embodiment of a system for roaming a group voice communication between a PMR radio system and a mobile telephone network system is illustrated. A server 300 capable of communicating with mobile devices 100 via IP may comprise functions, such as: members information 305, group information 310, roaming manager 315 and meet-me room environment 320. Server 300 may communicate with any number of mobile devices 100B-N via any network or protocol, including the GSM/GPRS, WiMAX, WLAN or a private radio, such as the PMR 446. Each of the mobile devices 100B-N may comprise a roaming function 313. Mobile devices 100A-N may be within a private radio or walky-talky range of each other and may maintain a voice communication with each other via the PMR modules. Mobile devices 100A-N may also be within a mobile telephone network coverage area and may be within a GSM/GPRS network signal range. In an instance that one or more of the mobile devices 100 step outside of the private radio communication range, server 300 may ensure that the group of mobile devices 100A-N maintain their audio communication by switching the audio communication from the PMR radio to another medium, such as the GSM, GPRS, VOIP, WiMAX or any other means via which an audio communication may be maintained. The server 300 may also check whether all of the mobile devices 100 are within the private radio or walky-talky communication range, and if so, the server may direct the mobile devices 100A-N to resume their conversation via the private radio communication on the selected channel of their PMR radio module.

Server 300 may be any server capable of providing services and functions described herein. In some embodiments, server 300 is a mobile device 100 comprising the additional server functionality described herein. Server 300 may include any functionality of a mobile device 100. The mobile device 100 may therefore comprise additional functionality from other mobile devices 100. In some embodiments, server 300 is not a mobile device 100, but rather a server dedicated to providing services or support to other computing devices, such as mobile telephones or computers. Server 300 may be a server of an internet provider or a mobile network provider. Server 300 may be a machine or a plurality of computing machines providing internet services to mobile computing devices, including access to web pages and other network related services. In other embodiments, server 300 is a mobile network service provider server, an internet provider server, a server of a WiMAX service or any other communication device capable of providing the service described herein.

Server 300 may comprise any computing device capable of communicating via a wireless internet protocol (IP) communication. Server 300 may comprise any combination of hardware and software for providing services and needs of programs or applications running on other computing devices. Server 300 may include functionality to communicate with other computing devices, such as mobile devices 100, via a network. Server 300 may communicate and provide services via any wired or wireless networks, including a world wide web (WWW), a Local Area Network (LAN), a Wide Area Network (WAN), a Bluetooth network, a WiMAX network or any other network.

Server 300 may communicate with other computing devices, such as mobile devices 100 using any communication protocol. Server 300 may send and receive communication via any internet layer protocol, such as the internet protocol (IP), internet control message protocol (ICMP) and internet group management protocol (IGMP). Server 300 may also communicate using any transport layer protocol, including the transmission control protocol (TCP), user datagram protocol (UDP), datagram congestion control protocol (DCCP) or any other transport layer protocol. Server 300 may also communicate using any application layer protocol, such as the hypertext transfer protocol (HTTP), Telnet protocol, simple mail transfer protocol (SMTP) or any other application layer protocol.

Server 300 may comprise any functionality to maintain communication between mobile devices 100A-N by transporting or roaming audio communication between the private radio system and the mobile telephone network system. Server 300 may include functionality to maintain information of the mobile devices 100A-N along with any information of any individual mobile device 100 or the mobile device group. Server 300 may comprise functionality to create and maintain an environment within which mobile devices 100A-N may maintain their audio communication. The server 300 may comprise functionality to check if all the mobile device group members 100A-N are within the private radio communication range of each other. Server 300 may comprise functionality to check if all of the members of the group are connected to the audio communication via the environment created by the server. Server 300 may comprise functionality to select an available channel and direct each of the mobile devices 100A-N to continue their audio communication on the selected channel of the PMR radio system.

Members information 305 may comprise any information of a mobile device 100A or the user of the mobile device 100. Member information 305 may comprise any information of a member of the group of mobile devices 100A-N involved in an audio communication. Member info 305 may include a mobile device identifier, such as an identification number or a device number. Member info 305 may comprise information regarding the member's PMR radio signal strength with respect to each other mobile device group member. Members information 305 may also include any information for maintaining IP or IP/TCP communication with the member via the GSM, GPRS or VOIP mobile communication.

Group information 310 may comprise any information regarding mobile devices 100A-N. Group information 310 may include information about the number of the members of the group and information about each of the members. Group information 310 may comprise a group identifier uniquely identifying the group. Group information 310 may comprise information about any member of the group that is missing, lost or outside of the private radio communication range. In some embodiments, group information 310 comprises mobile device 100 identifiers of each of the members that are not within the private radio communication range. In further embodiments, group information 310 comprises mobile device 100 identifiers of each of the members that are not in the meet-me room environment 320 communicating with other group members. Group information 310 may include signal strength of each of the devices for both the mobile network and the private radio network.

Roaming function 313 may operate on each individual mobile device 100A-N and may include any functionality for roaming communication between the PMR private radio communication and the mobile telephone network. Roaming function 313 may comprise hardware, software or any combination of hardware and software for enabling each mobile device to maintain an audio communication established via a private radio on a mobile network service, such as the GSM/GPRS. Roaming function 313 may comprise functionality for activating or deactivating GSM/GPRS and/or PMR radio service. Roaming function 313 may comprise functionality for performing signal check or keep-alive broadcasts between the mobile device group members 100A-N to establish if each of the devices has a sufficiently strong private radio signal. Roaming function 313 may search for the transmissions from each of the group members and return the result identifying the signal strength. Roaming function 313 may return to server 300 information identifying whether or not the device can establish the private radio communication with each of the other group members. Roaming function 313 of a host mobile device 100 may prompt other group members to send to the host mobile device 100 the response identifying the signal strength between the host mobile device 100 and each of the remaining mobile device group members. Roaming function 313 may perform in the background and may operate while the user communicates via the GSM/GPRS network.

Roaming manager 315 on the server 300 may comprise any functionality for directing and managing the roaming of the audio communications of a group of mobile devices between the PMR radio system and the mobile network. Roaming manager 315 may comprise hardware, software and any combination of hardware and software for enabling and managing roaming of audio communications between the PMR radio channels and a GSM/GPRS network. Roaming manager 315 may comprise functionality to request mobile devices 100A-N to join into a meet-me room environment 320 and enable the devices 100 to maintain the audio communication via the meet-me room environment. Roaming manager 315 may include any feature or functionality of a roaming function 313, including the ability to check if each of group members is within a private radio range of all the other group members. Roaming manager 315 may comprise functionality to select a channel for transferring the group communication or conversation from the mobile network or the meet-me room to the PMR radio. Roaming manager 315 may comprise functionality to transport the audio conversation back and forth between the mobile telephone network and the private radio. Roaming manager 315 may manage and/or coordinate operations or functions of the roaming functions 313 on each of the mobile devices 100.

Meet-me room environment 320 may comprise any functionality for providing mobile devices users with a means to communicate in a group, as a telephone conference, via a mobile telephone network. Meet-me room environment 320, or environment 320, may comprise functions, algorithms, executable program and logic for enabling an audio communication exchange via any one or more of: a GSM network, a GPRS network, VOIP, WiMAX, WLAN or any other communication medium or protocol. Environment 320 may include any functionality for providing mobile device users with a means to send a voice burst or transmission of voice data to other mobile device group members in the environment. Environment 320 may comprise functionality for enabling each of the mobile device group members to hear the voice transmission from the user transmitting. Environment 320 may include functionality for enabling only a single user to send voice transmission at a time, thus ensuring that other group members are listening. Environment 320 may simulate PMR radio conversation such that the group members do not feel the difference between the private radio communication and the communication via the server 300 or the mobile telephone network.

Referring now to FIG. 3B, an embodiment of a method of steps for maintaining private radio group communication by roaming the communication between the private radio system and the mobile telephone network is illustrated. At step 335, a server 300 may detect that a mobile device member of a group of mobile device 100 members conversing via a private radio PMR channel has lost contact. At step 340, remaining members that are still within the range of each other via the PMR radio channel may establish a connection with a server via a mobile telephone network to join a meet-me room hosted or managed by the server 300. At step 345, the server provides the members of the group, including the lost member, with a means to maintain audio communication within the meet-me room environment managed by the server 300. At step 350, the server determines if each of the members within the meet-me room is within the private radio communication range of all the other group members. At step 355, the server manages the transfer of the communication from the meet-me room environment to a selected PMR mobile radio channel.

Referring to FIG. 3B in a greater detail, at step 335, a group of mobile devices may be established by a group of users who want to form a group, such as for a group activity. The group of mobile devices may be established by a plurality of mobile devices in proximity to each other and/or under control or held by such users. The group of mobile devices may be established by a grouping function or application executing on each of the mobile devices. Via one or more communication and/or grouping schemes of the grouping function/application, each of the mobile devices may identify and communicate other devices to be part of and form the group. Each mobile device of the group receives information on a number of mobile devices of the group and identification of each mobile device. One or more of the mobile device of the group may communicate with one or more other mobile devices of the group, using private radio communications via their respective private mobile radio modules.

A server 300 may detect that a mobile device 100 of a group of mobile devices 100 conversing via a channel of a PMR private radio has lost the signal with one or more members of the group. Each of the mobile device of the group may detect that a mobile device 100 of a group of mobile devices 100 conversing via a channel of a PMR private radio has lost the signal with one or more members of the group. Either the server, one or more of the mobile devices may determine that a mobile device is no longer in communication via the private mobile radio module In some embodiments, the server 300 detects that a mobile device 100 of a member of the group has lost signal. In some embodiments, a mobile device 100 which is not the server 300 detects that a third mobile device 100 has lost contact with the group. Mobile devices of a group may periodically transmit a message, such as a keep-alive message. The message may be transmitted from each of the members and be used to identify if all the members are within the range of the transmitting member. In other embodiments, mobile devices 100 periodically send a transmission to the server 300 on a mobile device 100 informing the server the status of their PMR radio signal. The status may indicate whether or not the mobile device is in the range with each of the other members of the group. The mobile device 100 or the server 300 receiving the transmission may determine, upon detecting that a particular mobile device 100 has not transmitted a message, that the particular mobile device is lost or absent. In some embodiments, a mobile device 100 or server 300 monitor signal strength from each of the mobile devices 100 of the group. The server 300 or the mobile device 100 may send a request to one or more mobile devices 100 and monitor the responses based on the identifiers transmitted back with the responses to the request. As each of the devices may have a unique identifier, the mobile device or the server may determine which of the devices has not responded and based on the absence of the response, determine, which one of the devices is out of the range. In some embodiments, the server 300 or the mobile device receives information from each of the devices of the members of the group and based on the information determines that a member is out of the private radio communication range.

At step 340, upon detecting that a mobile device 100 is out of range or lost, the remaining mobile devices of the group may establish a connection with the server 300 via a communication network and may join a meet-me room environment 320 managed by the server 300. In some embodiments, each mobile device of the group responsive to the determination that one of the mobile devices of the group is out range of the their private mobile radio module may activate their cellular communications module. Each of the mobile devices of the group may determine that a mobile device of the group is outside a predetermined range limit of the private mobile radio module, has lost a signal via the private mobile radio module or that the mobile device is no longer in communication upon not receiving a keep-alive message within a predetermined time period.

The communication networks or mediums via which the mobile devices may establish a connection may include any one or a combination of a GSM network, GPRS network, VOIP, WLAN or WiMAX. Mobile device 100 may establish an IP connection with the server 300. In some embodiments, mobile device group members establish a TCP/IP connection. The group members may activate the GSM/GPRS module and send a connection request to the server 300. The server 300 may initiate the connection by seeking out the group members and sending the request. The server 300 may be informed as to the present group members identified via individual identifiers. The server 300 may identify the group using the group identifier. The meet-me room environment 320 may be selected based on the group identifier. The server 300 may monitor the members present in the meet-me room and may wait for the lost member to establish the connection with the server. Server 300 may identify the lost member via the unique mobile device identifier of the member. The server 300 may establish the connection with the lost member and enable the member to rejoin the audio conversation within the meet-me room. Server 300 may monitor the signal status of each of the members communicating within the meet-me room environment. Each of the group members present may continue the conversation seamlessly within the meet-me room.

At step 345, the server may enable the group members to maintain their audio communication within the meet-me room environment. The server may receive group information from one or more of the mobile devices of the group. In some embodiments, the server 300 establishes a telephone conference between the group members. The server may manage the conversation within the meet-me room to simulate the conversation as occurring via the PMR mobile radio. For example, the server may enable only a single member to talk at one time, thus making others listen while the user is talking, just as with the private radio communication. The mobile device users may continue using the PMR radio features or commands on their devices, including the roger button or button for requesting to send a voice transmission. The server may establish a telephone conference or conference bridge between the mobile devices of the group. The server may simulate audio communications between the mobile devices of the group, as occurring via the private module radio modules, via the telephone conference or conference bridge.

At step 350, the server 300 determines if each of the members of the mobile device group is within the private radio communication range of the other group members. While the members are involved in the audio communication the server 300 may seamlessly instruct the mobile devices 100 of the group to send the keep alive messages and check the PMR radio signal strength with respect to each other. For example, the roaming manager 315 of the server 300 may manage the PMR mobile radio communication in which a mobile device sends a transmission to other mobile devices and each of the receiving mobile devices responds with a transmission indicating the signal strength. Should all of the devices indicate that they can receive communication from each of the mobile devices, the roaming manager 315 of the server 300 may determine that all the mobile devices 100 are once again within the private radio communication range. In some embodiments, roaming functions 313 of the mobile devices 100 initiate the PMR communication between the devices to determine the signal strength for each of the devices. The roaming functions 313 or the roaming manager 315 may consolidate all the data from each of the mobile devices 100 and determine if all the devices have a sufficiently strong signal to communicate with each other via PMR radio module.

At step 355, the server managing the transfer of the communication from the meet-me room to a selected channel of the PMR mobile radio. Upon determining that each of the mobile devices is within a private radio communication range of all other mobile devices 100 of the group, the server may identify an available channel on the PMR radio. Once the server 300 identifies the channel, the server may send a request to each of the mobile devices to activate the PMR module and join the selected channel. Each of the mobile devices may join the selected channel responsive to the request and seamlessly transfer the conversation from the meet-me room environment of the server 300 to the selected channel of the PMR radio. The group devices may thus continue their conversation seamlessly on the channel of the PMR radio.

What is claimed:

1. A method for seamlessly communicating among a plurality of mobile devices comprising private mobile radio modules, the method comprising:
(a) establishing a group of mobile devices, each of the mobile devices comprising a cellular communications module and a private mobile radio module to communicate with other mobile devices in the group using private radio communications;
(b) communicating audio, by a mobile device of the group with one or more mobile devices of the group, using private radio communications via the private mobile radio module;
(c) determining, by each mobile device of the group, that the mobile device is no longer in communication via the private mobile radio module;
(d) deactivating, by each mobile device of the group responsive to the determination, their private mobile radio module and activating their cellular communications module; and
(e) establishing, by each mobile device of the group, a connection with the server using their cellular communications module, the server providing audio communications for the group.

2. The method of claim 1, further comprising establishing, by the server, a telephone conference between the mobile devices of the group.

3. The method of claim 1, further comprising simulating, by the server, audio communications between the mobile devices of the group, as occurring via the private module radio modules.

4. The method of claim 1, further comprising determining, by the server, that each mobile device of the group is within a predetermined range limit of the private mobile radio module, and responsive to the determination, sends to each mobile device of the group an instruction to establish communications via their private mobile radio modules with the other mobile devices.

5. The method of claim 1, wherein step (a) further comprises receiving, by each mobile device of the group, information on a number of mobile devices of the group and identification of each mobile device.

6. The method of claim 1, wherein step (b) further comprises transmitting, by the mobile device, a keep-alive message to each of the other mobiles devices of the group.

7. The method of claim 1, wherein step (c) further comprises determining, by each of the mobile devices of the group, that the mobile device is outside a predetermined range limit of the private mobile radio module.

8. The method of claim 1, wherein step (c) further comprises determining, by each mobile device of the group, that the mobile device has lost a signal via the private mobile radio module.

9. The method of claim 1, wherein step (c) further comprises determining, by each mobile device of the group, that the mobile device is no longer in communication upon not receiving a keep-alive message within a predetermined time period.

10. The method of claim 1, wherein step (e) further comprises receiving, by the server, group information from one or more of the mobile devices of the group.

11. A system for seamlessly communicating among a plurality of mobile devices comprising a private mobile radio module, the system comprising:
a plurality of mobile devices establishing a group, each of the plurality of mobile devices comprising a cellular communications module and a private mobile radio module to communicate with other mobile devices in the group using private radio communications;
a mobile device of the group in audio communications with one or more mobile devices of the group using private radio communications via the private mobile radio module;
a roaming manager of each of the plurality of mobile devices determines that the mobile device is no longer in communication via the private mobile radio module and responsive to the roaming manager, the private mobile radio module is deactivated and the cellular communications module is activated; and
wherein each of the plurality of mobile devices of the group establishes a connection with the server using their cellular communications module, the server providing audio communications for the group.

12. The system of claim 11, wherein the server further establishes a telephone conference between the mobile devices of the group.

13. The system of claim 11, wherein the server further simulates audio communications between the mobile devices of the group as occurring via the private module radio modules.

14. The system of claim 11, wherein the server further determines that each of the mobile devices of the group are within a predetermined range limit of the private mobile radio module, and responsive to their determination, sends to each of the mobile device an instruction to establish communications via their private mobile radio modules.

15. The system of claim 11, wherein each mobile device receives information on a number of mobile devices of the group and identification of each mobile device.

16. The system of claim 11, wherein the mobile device transmits a keep-alive message to each of the other mobiles devices of the group.

17. The system of claim 11, wherein the roaming manager determines that the mobile device is outside a predetermined range limit of the private mobile radio module.

18. The system of claim 11, wherein the roaming manager determines that the mobile device has lost a signal via the private mobile radio module.

19. The system of claim 11, wherein the roaming manager determines that the mobile device is no longer in communication upon not receiving a keep-alive message within a predetermined time period.

20. The system of claim 11, wherein the server receives group information from one or more of the mobile devices of the group.
